(19) United States
(12) Patent Application Publication
(10) Pub. No.: US 2025/0308493 A1
(43) Pub. Date: Oct. 2, 2025

(54) KEYBOARD DEVICE AND METHOD FOR REGULATING KEY SWINGING

(71) Applicant: Roland Corporation, Shizuoka (JP)

(72) Inventors: Keigo Tsutaki, Shizuoka (JP); Hajime Hisamitsu, Shizuoka (JP); Yukihide Takata, Shizuoka (JP); Shiro Uno, Shizuoka (JP)

(73) Assignee: Roland Corporation, Shizuoka (JP)

(21) Appl. No.: 19/234,305

(22) Filed: Jun. 11, 2025

Related U.S. Application Data
(63) Continuation of application No. 18/977,879, filed on Dec. 11, 2024.

(30) Foreign Application Priority Data
Dec. 26, 2023 (JP) 2023-220031
Sep. 26, 2024 (JP) 2024-167809

(51) Int. Cl. G10H 1/34

(52) U.S. Cl. CPC G10H 1/346; G10H 2220/221; G10H 2220/275

(57) ABSTRACT

A keyboard device and a method for detecting key-pressing information thereof are provided. The keyboard device includes a key configured to displace between a static position before key-pressing and a terminal position of key-pressing; and a sensor configured to output an output value increased or decreased in accordance with a position of the key. The keyboard device is configured to detect acceleration/deceleration of the key in a key-pressing direction from the output value of the sensor, and correct the output value of the sensor indicating the terminal position based on the position of the key where the deceleration occurs.

### CROSS-REFERENCE TO RELATED APPLICATION

This application is a continuation application of and claims priority benefit of a U.S. application Ser. No. 18/977,879, filed on Dec. 11, 2024, which claims the priority benefits of Japan application serial no. 2023-220031, filed on Dec. 26, 2023 and Japan application serial no. 2024-167809, filed on Sep. 26, 2024. The entirety of each of the above-mentioned patent applications is hereby incorporated by reference herein and made a part of this specification.

### BACKGROUND

### Technical Field

The invention relates to a keyboard device and a method for regulating key swinging, and particularly to a keyboard device and a method for regulating key swinging that can accurately detect aftertouch.

### Description of Related Art

For example, Patent Document 1 describes a technology in which, after the displacement of the keyboard 2 (key) at the time of key-pressing is regulated by stoppers 8a, 8b, the performance in which a keyboard 2 (hereinafter referred to as “aftertouch”) is further pushed in is detected by a pressure sensor 5. In this technology, a stopper 14 is integrally provided with the pressure sensor 5, and the aftertouch is detected by the hammer 3, which swings in conjunction with the keyboard 2, pressing the pressure sensor 5 via the stopper 14.

### PRIOR ART DOCUMENT(S)

### Patent Document(s)

[Patent Document 1] Japanese Patent Application Laid-open No. H08-234751 (e.g., para. 0016 to 0020, FIGS. 1, 2)

In a keyboard device with a function to detect aftertouch as described in the conventional technology, if the stopper 8a, 8b that regulates the displacement of the keyboard 2 is formed to be relatively rigid, it becomes easier to obtain a full stroke feel (the sensation of reaching the terminal of normal performance) when the keyboard 2 contacts the stoppers 8a, 8b at the time of key-pressing. Therefore, it is possible to prevent a performer conducting normal performance from pressing the keyboard 2 into the aftertouch region.

However, when the stopper 8a,8b is formed to be rigid, it becomes difficult to significantly displace a hammer 3 (keyboard 2) even when the keyboard 2 contacting the stoppers 8a, 8b is further pressed. In other words, despite the intention to perform aftertouch, there may be cases where the pressure sensor 5 is not appropriately pressed by the hammer 3. As a result, the aftertouch cannot be accurately detected.

Meanwhile, when the stoppers 8a, 8b are simply formed to be soft, it becomes difficult to obtain the full stroke feel when the keyboard 2 contacts the stoppers 8a, 8b. As a result, the performer conducting normal performance may unintentionally press the keyboard 2 into the aftertouch region. Consequently, a key-pressing operation intended for normal performance may be erroneously detected as aftertouch.

The invention provides a keyboard device and a method for regulating key swinging that can accurately detect an aftertouch.

### SUMMARY

A keyboard device according to an embodiment of the invention includes: a key; a key-pressing stopper; and a sensor. The key-pressing stopper regulates swinging of the key at a time of key-pressing. The sensor detects, as an aftertouch, a displacement of the key at a time when the key is further pushed in after the swinging of the key is regulated by the key-pressing stopper. The key-pressing stopper includes: a first cushion layer; and a rigid layer. The first rigid layer is laminated on a surface layer side with respect to the first cushion layer and is more rigid than the first cushion layer.

A method for regulating key swinging according to an aspect of the invention is provided for a keyboard device. The keyboard device includes: a key; a key-pressing stopper; and a sensor. The key-pressing stopper regulates swinging of the key at a time of key-pressing, and the sensor detects, as an aftertouch, a displacement of the key at a time when the key is further pushed in after the swinging of the key is regulated by the key-pressing stopper. The method includes: regulating the swinging of the key by using the key-pressing stopper. The key-pressing stopper includes: a first cushion layer; and a rigid layer. The first cushion layer is relatively soft, and the rigid layer is laminated on a surface layer side with respect to the first cushion layer and is more rigid than the first cushion layer.

### BRIEF DESCRIPTION OF THE DRAWINGS

FIG. 1 is a cross-sectional view of a keyboard device according to a first embodiment.

FIG. 2 is an exploded perspective view of the keyboard device showing a state where a white key and a displacement member have been removed.

FIG. 3 is a perspective view of the holder.

FIG. 4A is a partially enlarged cross-sectional view of the keyboard device showing a state before inserting a guide pin of a linkage member into a groove of a displacement member, and FIG. 4B is a partially enlarged cross-sectional view of the keyboard device showing the displacement member rotated by its own weight.

FIG. 5 is an exploded perspective view of the keyboard device showing a state where a substrate and a fixed member have been removed.

FIG. 6A is a side view of the keyboard device as viewed from a direction of an arrow VIa in FIG. 5, and FIG. 6B is a side view of the keyboard device showing a process for attaching the substrate to the holder and the fixed member.

FIG. 7A is a partially enlarged cross-sectional view of the keyboard device showing the state during a state in the middle of key-pressing in which a white key is pressed from the state shown in FIG. 1, and FIG. 7B is a partially enlarged cross-sectional view of the keyboard device showing a state where the white key that is further pressed from the state shown in FIG. 7A has come into contact with a key-pressing stopper.

FIG. 8A is a partially enlarged cross-sectional view of the keyboard device showing a state where the white key has been further pushed in from the state shown in FIG. 7B, and FIG. 8B is a graph showing a relationship between a stroke length of the white key and a sensor output value.

FIG. 9A is a partially enlarged cross-sectional view of the keyboard device along a line IXa-IXa in FIG. 7B, and FIG. 9B is a partially enlarged cross-sectional view of the keyboard device along a line IXb-IXb in FIG. 8A.

FIG. 10 is a functional block diagram of the keyboard device.

FIG. 11 is a graph showing the time variation of the position, the velocity, and the acceleration of the white key when normal key-pressing is performed.

FIG. 12 is a graph showing a relationship between the stroke length of the white key and the sensor output value, and also showing a relationship between various positions such as a static position of the white key and a sound production position.

FIG. 13 is a graph showing the time variation of the position, the velocity, and the acceleration of the white key when an aftertouch is performed following normal key-pressing.

FIG. 14A is a block diagram showing an electrical configuration of the keyboard device, and FIG. 14B is a flowchart of a correction process for a key position.

FIG. 15 is a flowchart of the correction process for the static position.

FIG. 16 is a flowchart of the correction process for the terminal position.

FIG. 17 is a flowchart of the correction process for the aftertouch position.

FIG. 18 is a cross-sectional view of a keyboard device in a second embodiment.

FIG. 19A is a partially enlarged cross-sectional view of the keyboard device showing an enlarged view of an XIXa portion in FIG. 18, and FIG. 19B is a partially enlarged cross-sectional view of the keyboard device showing the state where the white key is pressed from the state in FIG. 19A to the aftertouch position.

FIG. 20 is a cross-sectional view of a conventional keyboard device.

### DESCRIPTION OF THE EMBODIMENTS

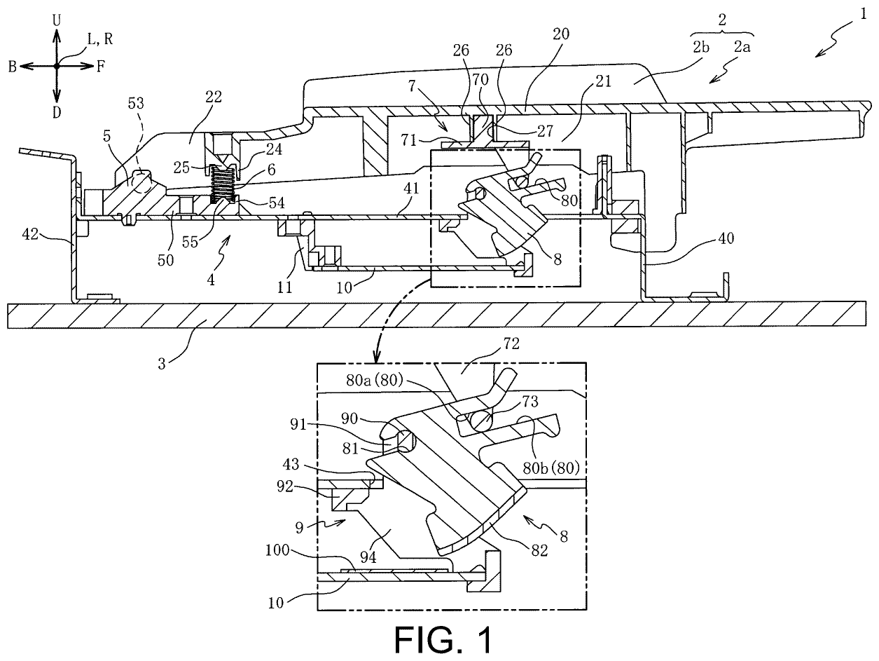

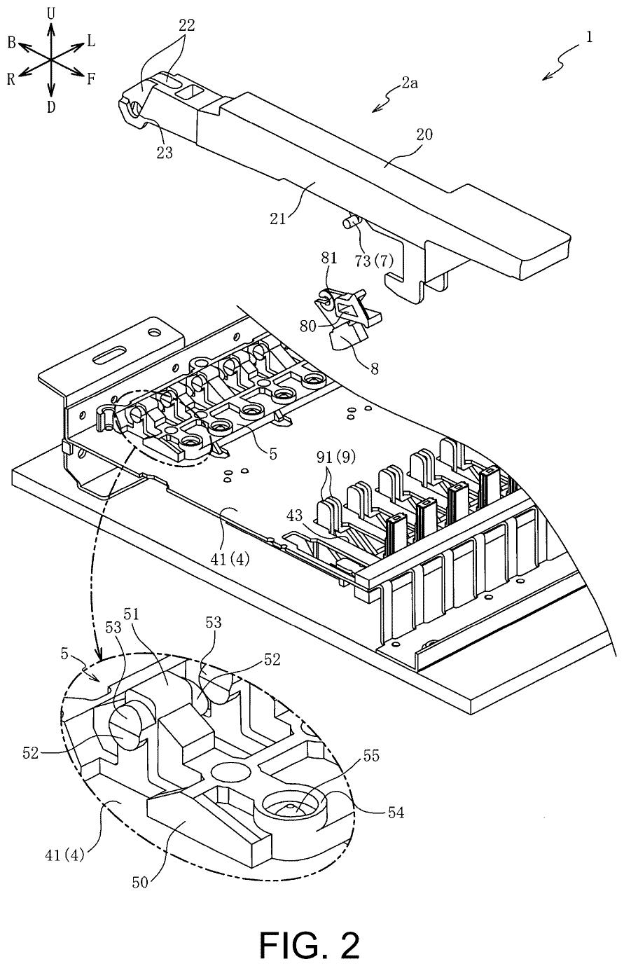

The following description refers to the attached drawings to explain exemplary embodiments. Firstly, referring to FIG. 1, the overall configuration of the keyboard device 1 of the first embodiment will be described. FIG. 1 is a cross-sectional view of a keyboard device 1 in the first embodiment. An arrow U-D direction, an arrow F-B direction, and an arrow L-R direction in FIG. 1 indicate the upper-lower direction, the front-rear direction, and the left-right direction (the direction in which multiple keys 2 are arranged, hereinafter referred to as the “scale direction”) of the keyboard device 1, respectively, and the same applies to FIG. 2 and subsequent figures. FIG. 1 is a cross-sectional view of the keyboard device 1 cut along a plane perpendicular to the scale direction.

As shown in FIG. 1, the keyboard device 1 includes multiple (in this embodiment, 88) keys 2, and is a device that forms a keyboard instrument (synthesizer). The keys 2 are formed by multiple (in the embodiment, 52) white keys 2a for playing natural notes and multiple (in this embodiment, 36) black keys 2b for playing derived notes, and the white keys 2a and the black keys 2b are arranged in the scale direction (arrow L-R direction).

The keyboard device 1 includes a base plate 3 for supporting the keys 2. The base plate 3 is formed in a plate shape extending in the scale direction by using a synthetic resin or a steel plate, and a chassis 4 is supported on the upper surface of the base plate 3.

A front leg part 40 is provided at a front end portion (the end on the arrow F side) of the chassis 4, and the front leg part 40 is fixed to the base plate 3. The front leg part 40 extends upward from the base plate 3, and from the upper end of the front leg part 40, a support part 41 for supporting the key 2 extends toward the rear side (arrow B side). The front leg part 40 and the support part 41 are integrally formed by performing a bending machining process on a metal plate.

The rear end of the support part 41 is fixed (screwed or welded) to a rear leg part 42 made of metal and extending in the upper-lower direction, and the chassis 4 formed of the respective parts 40 to 42 is formed in a C-shape having a space between the support part 41 and the base plate 3 when viewed in the scale direction.

Next, referring to FIG. 1 and FIG. 2, the configuration for rotating the white key 2a and the configuration for linking a displacement member 8 to the rotation of the white key 2a will be explained in detail. However, such configuration is substantially the same for the black key 2b. Therefore, the effects produced by the configuration of the white key 2a described below are similarly achieved in the black key 2b as well. FIG. 2 is an exploded perspective view of the keyboard device 1 showing the state with the white key 2a and the displacement member 8 removed.

As shown in FIGS. 1 and 2, the white key 2a includes an upper plate 20 whose upper surface (the surface on the arrow U side) is configured as a key-pressing surface to be pressed down by a performer, and a pair of side plates 21 extending downward from both ends of the upper plate 20 in the left-right direction (arrow L-R direction). The plate-shaped upper plate 20 and side plates 21 are integrally formed by using a resin material, and the white key 2a is formed in a box shape with an opening at the bottom.

A plate-shaped protrusion part 22 protrudes rearward from the rear end (the end on the arrow B side) of the white key 2a. The protrusion part 22 is provided as a pair spaced apart in the scale direction (arrow L-R direction) (see FIG. 2), and the pair of protrusion parts 22 are supported by a key shaft member 5.

The key shaft member 5 includes an attached part 50 that is attached to the upper surface of the chassis 4 (support part 41). The attached part 50 is formed to be substantially plate-shaped and extends in the scale direction, and, from the rear end side of the attached part 50, an insertion part 51 (see the enlarged portion in FIG. 2) rises upward.

The insertion part 51 is arranged side-by-side in the scale direction, and, at the upper end side of the insertion part 51, a substantially cylindrical shaft part 52 is formed. The parts 50 to 52 of the respective key shaft members 5 are integrally formed by using a resin material (synthetic resin).

The shaft part 52 protrudes in both sides of the scale direction from the insertion part 51, and in each of the pair of protrusion parts 22 of the white key 2a, a circular insertion hole 23 allowing insertion of the the shaft part 52 is formed. When inserting the shaft part 52 into the insertion hole 23, the insertion is guided by an inclined surface 53 (see the enlarged portion in FIG. 2) formed on the shaft part 52.

The inclined surface 53 is inclined upward so as to diagonally cut off (approaching the insertion part 51) the upper end of the tip end surface of the shaft part 52. Therefore, by pushing down the pair of protrusion parts 22 of the white key 2a from the upper side toward the insertion part 51 (inserting the insertion part 51 between the pair of protrusion parts 22), the protrusion parts 22 slide along the inclined surface 53 of the shaft part 52. Through such sliding, the pair of protrusion parts 22 elastically deform to expand an interval therebetween. Therefore, the shaft part 52 can be easily inserted into the insertion hole 23 of the white key 2a. By inserting each of the pair of shaft parts 52 into the insertion hole 23, the white key 2a is supported by the key shaft member 5.

On the upper surface of the front end side (the end on the arrow F side) of the attached part 50, a cylindrical shaped retention wall 54 is formed for holding a coil spring 6 (see FIG. 1), and the retention walls 54 are arranged in side-by-side in the scale direction. At the central portion of the inner peripheral side of each retention wall 54, a conical shaped convex part 55 protruding upward is formed.

On the white key 2a, a retention wall 24 (see FIG. 1) is formed at a position facing the retention wall 54 in the upper-lower direction. The retention wall 24 is formed in a cylindrical shape extending downward from the upper plate 20 of the white key 2a, and on the inner peripheral side of the retention wall 24, a conical-shaped convex part 25 protruding downward is formed. The coil spring 6 is held on the inner peripheral side of the retention walls 24, 54 by being sandwiched from top and the bottom by the convex part 55 of the key shaft member 5 and the convex part 25 of the white key 2a. When the white key 2a is pressed, a key-pressing feel is provided by the elastic force of the coil spring 6, while when the key is released, the white key 2a returns to the static position (the height at which the key is stationary before being pressed) by the elastic recovery force of the coil spring 6.

At the approximate central portion of the white key 2a in the front-rear direction (arrow F-B direction), a plate-shaped partition plate 26 (see FIG. 1) extending downward from the upper plate 20 is formed. The partition plates 26 are provided as a pair with an interval therebetween in the front-rear direction. The partition plate 26 is integrally formed with the upper plate 20 and the side plates 21 so as to connect the pair of side plates 21 in the scale direction, and a linkage member 7 is attached to a recess part 27 surrounded by the respective plates 20, 21, 26.

The linkage member 7 is a component for linking the displacement member 8 to the swinging of the white key 2a at the time of key-pressing and key-release. The linkage member 7 includes a columnar inserted part 70 extending in the upper-lower direction, a plate-shaped extension part 71 projecting forward and backward from the lower end of the inserted part 70, and a plate-shaped protrusion part 72 (see the enlarged portion in FIG. 1) protruding downward from the front end portion of the extension part 71. The parts 70-72 are integrally formed by using a resin material.

The inserted part 70 is formed in a shape corresponding to the recess 27 of the white key 2a, and the linkage member 7 is attached to the white key 2a by inserting the inserted part 70 into the recess 27 and adhering the inserted part 70 to the white key 2a. At the lower end of the protrusion part 72, a cylindrical guide pin 73 protruding in the scale direction (arrow R side) is integrally formed, and the guide pin 73 is hooked to a groove 80 formed in the displacement member 8.

The groove 80 is a groove that penetrates the two side surfaces of the displacement member 8 facing the scale direction and extends in a direction perpendicular to the scale direction (inclined upward toward the upper front side in the state where the white key 2a is located at in the static position). In the static position before the white key 2a is pressed (the state shown in FIG. 1), the groove 80 extends to intersect with the displacement trajectory of the guide pin 73 around the shaft part 52. The displacement member 8 is linked to the rotation of the white key 2a by the sliding of the guide pin 73 along the groove 80. In the following description, among the groove 80 of the displacement member 8, the upper and lower surfaces on which the guide pin 73 slides at the time of key-pressing (key-release) of the white key 2a are referred to as an upper slide surface 80a and a lower slide surface 80b.

The displacement member 8 has a shaft hole 81 that penetrates through the displacement member 8 in the scale direction, and a rotation shaft 90 (see FIG. 1) formed on the holder 9 is inserted into the shaft hole 81. Accordingly, the displacement member 8 is rotatably supported on the holder 9. In the following description, in the state where the displacement member 8 is supported on the rotation shaft 90, the outer surface of the displacement member 8 facing a direction perpendicular to the axial direction (scale direction) of the rotation shaft 90 is referred to as the “outer peripheral surface”.

On the outer peripheral surface of the displacement member 8, a detected part 82 (see the enlarged portion in FIG. 1) is formed by adhering a metal plate or applying plating. A substrate 10 is provided at a position facing the detected part 82 (below the displacement member 8), and a coil 100 (see the enlarged portion in FIG. 1) that generates a magnetic field is formed on the substrate 10.

The coil 100 is formed by a conductive pattern on the substrate 10, but in FIG. 1, the coil 100 (thickness of the coil 100) on the substrate 10 is schematically illustrated. As will be described in detail later, the key-pressing information of the white key 2a is detected through the displacement of the detected part 82 of the displacement member 8 towards the region facing the coil 100 (hereinafter referred to as the “detection region”).

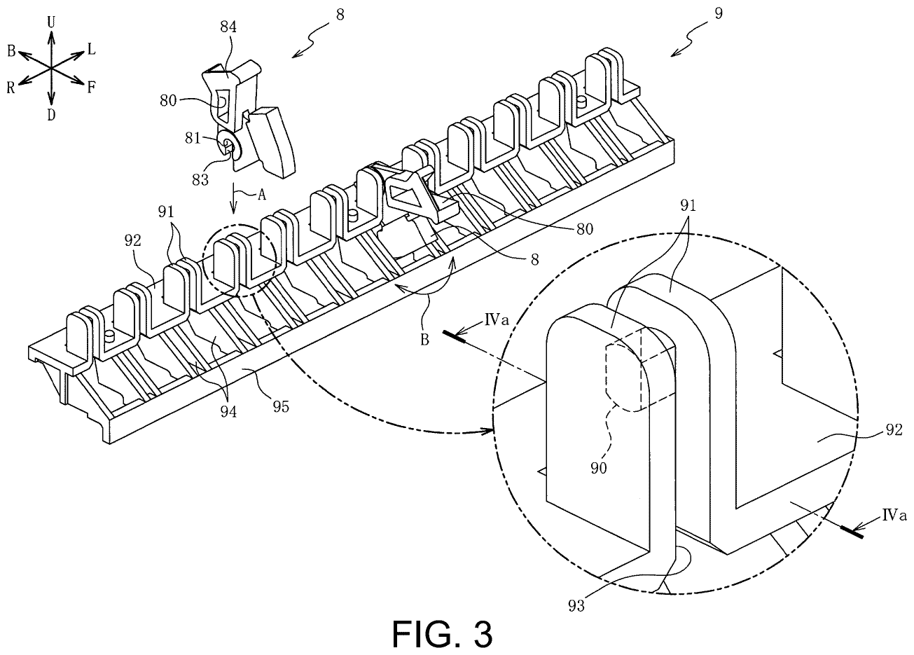

Next, referring to FIG. 3, the detailed configuration of the holder 9 will be described, together with reference to FIG. 1 and FIG. 2 as appropriate. FIG. 3 is a perspective view of the holder 9. It should be noted that FIG. 3 illustrates the holder 9 viewed from the same angle as in FIG. 2.

As shown in FIG. 3, the holder 9 includes a plate-shaped wall part 91 with an integrally formed rotation shaft 90 (see the enlarged portion in FIG. 3), and the interval between a pair of the wall parts 91 facing each other in the scale direction is connected by the rotation shaft 90. The rotation shaft 90 is formed in an elliptical shape extending vertically, and the displacement member 8 has a notch 83 formed for inserting the rotation shaft 90 into the shaft hole 81. The notch 83 is a groove (a hole penetrating through the displacement member 8 in the scale direction) that linearly connects the outer peripheral surface of the displacement member 8 to the shaft hole 81, and extends in a direction opposite to the groove 80 by sandwiching the shaft hole 81. The groove width of the notch 83 is set to be substantially the same as the front-rear direction dimension of the elliptical rotation shaft 90 (the width dimension of the rotation shaft 90 in the arrow F-B direction).

Therefore, as indicated by the arrow A in FIG. 3, by inserting the displacement member 8 between the pair of the wall parts 91, so that the rotation shaft 90 is inserted into the notch 83 in the state in which the notch 83 of the displacement member 8 faces downward, the rotation shaft 90 is inserted into the shaft hole 81. The diameter of the shaft hole 81 is substantially the same as the upper-lower direction dimension of the rotation shaft 90 (the longitudinal dimension of the rotation shaft 90 in the arrow U-D direction). After the rotation shaft 90 is inserted into the shaft hole 81 from the notch 83, by rotating the displacement member 8 to orient the notch 83 toward the rear side (arrow B side), the displacement member 8 is pivotally supported by the rotation shaft 90.

The holder 9 includes a attached part 92 that is substantially plate-shaped and extends in the scale direction, and the attached part 92 is attached to the support part 41 of the chassis 4 (see FIG. 1). Multiple wall parts 91 arranged in the scale direction stand upward from the attached part 92, and if the wall parts 91 provided as a pair and sandwiching the displacement member 8 is considered as one set, multiple sets of wall parts 91 are arranged in the scale direction. In the embodiment, the displacement members 8 for one octave (12 keys) are pivotally supported by one holder 9. The attached part 92 is fixed (screwed) to the lower surface of the support part 41 of the chassis 4 (see FIG. 1), and the wall parts 91 are inserted from below into through holes 43 (see FIG. 2) formed in the support part 41.

A through hole 93 (see the enlarged portion in FIG. 3) penetrating through the attached part 92 in the upper-lower direction is formed between the pair of wall parts 91, and a portion of the displacement member 8 is inserted into this through hole 93. That is, in the state where the displacement member 8 is pivotally supported by the holder 9, the portion on the lower end side of the displacement member 8 is positioned below the attached part 92 (the support part 41 of the chassis 4) (see FIG. 1), and the displacement of the displacement member 8 in such position is allowed by the through hole 93.

A hanging part 94 that is in a plate shape descends and has a downward inclination towards the front lower side from the attached part 92 of the holder 9. Considering a pair of the hanging parts 94 facing each other by sandwiching the displacement member 8 as one set, multiple sets of hanging parts 94 are aligned in the scale direction, and the lower ends of the sets of hanging parts 94 are connected in the scale direction by a connection part 95. Each of the parts 91 to 95 of the holder 9 including the rotation shaft 90 is integrally formed using a resin material. However, the holder 9 may also be formed by multiple components.

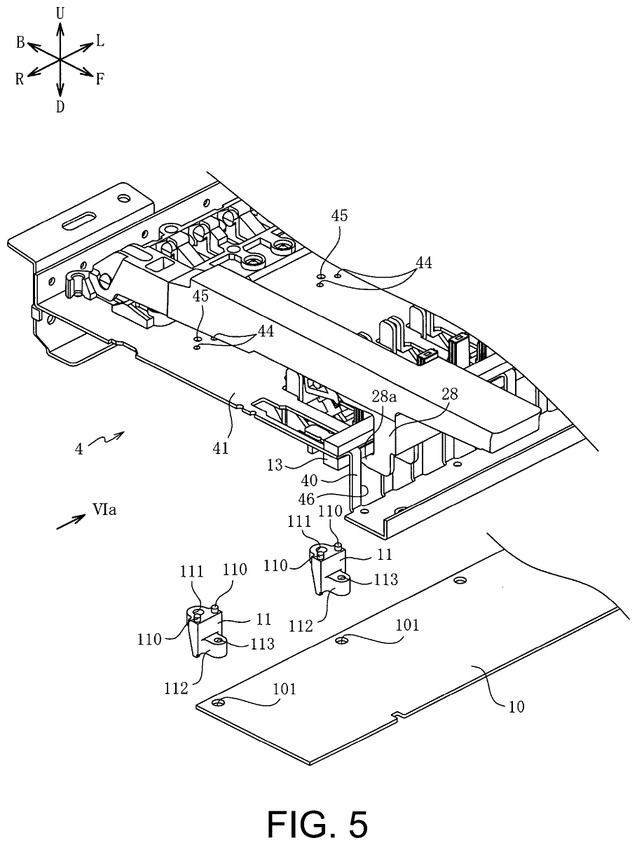

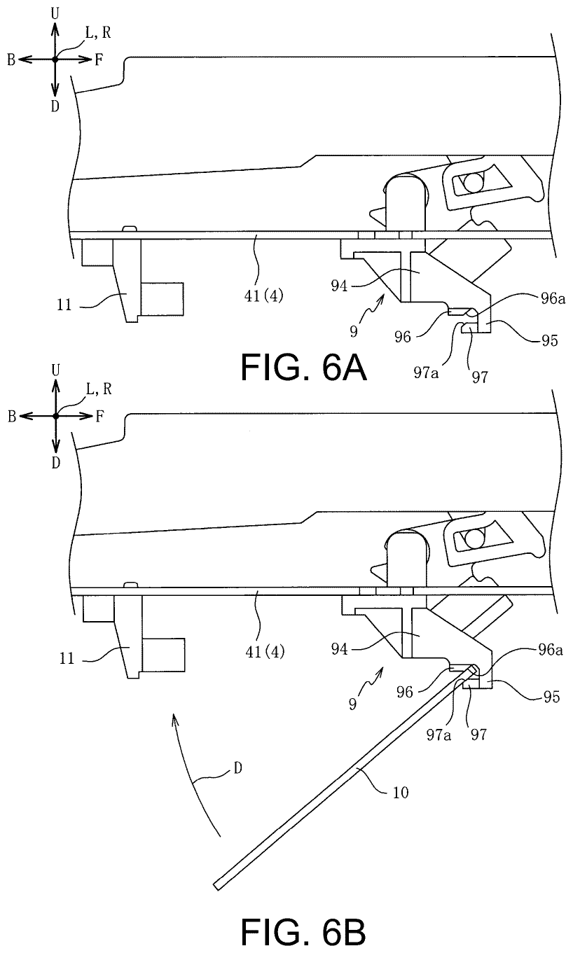

The front end of the substrate 10 (see FIG. 1) is supported on the connection part 95, and the rear end of the substrate 10 is supported on the chassis 4 (support part 41) via the fixed member 11 (see FIG. 1). The details of the support structure for the substrate 10 will be described later with reference to FIG. 5 and FIG. 6.

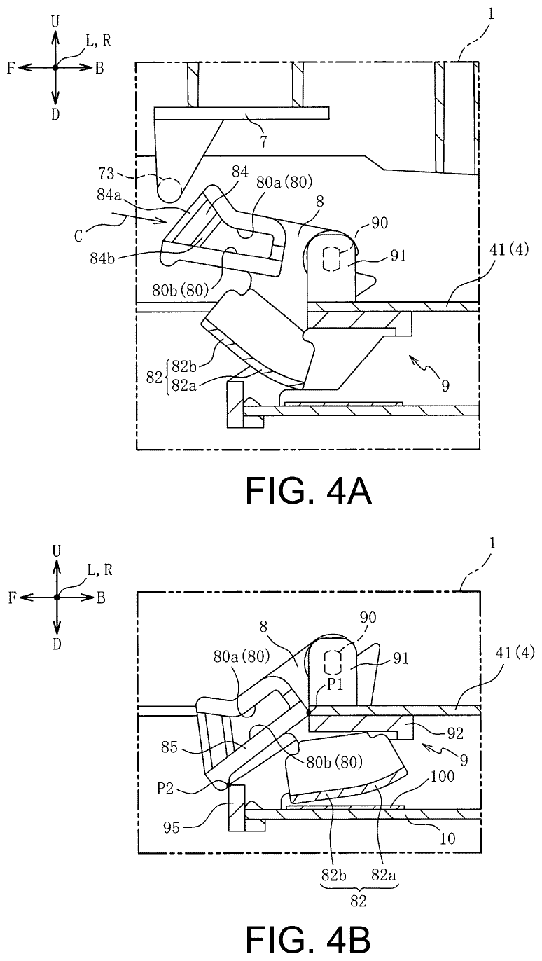

As indicated by arrow B in FIG. 3, in the state where the displacement member 8 is pivotally supported by the holder 9, it is possible to move the displacement member 8 (oscillate the displacement member 8 in the scale direction) through twisting in the scale direction. This is because, in addition to a slight gap between the rotation shaft 90 and the shaft hole 81, the pair of wall parts 91 are elastically deformable. The guide pin 73 (see FIG. 4A) of the linkage member 7 is engaged with the groove 80 through swinging of the displacement member 8 in the scale direction.

The engagement method will be described with reference to FIG. 3 and FIGS. 4A and 4B. FIG. 4A is a partially enlarged cross-sectional view of the keyboard device 1 showing a state before inserting the guide pin 73 of the linkage member 7 into the groove 80 of the displacement member 8, and FIG. 4B is a partially enlarged cross-sectional view of the keyboard device 1 showing the displacement member 8 rotated by its own weight. In FIG. 4A, the state where the holder 9 is assembled to the support part 41 of the chassis 4 is illustrated, and FIG. 4A corresponds to a cross-sectional view cut along the line IVa-IVa shown in the enlarged portion of FIG. 3. Additionally, FIGS. 4A and 4B are side views of the displacement member 8, but hatching is added to the detected part 82 for the ease of understanding.

As shown in FIG. 3 and FIGS. 4A and 4B, the groove 80 of the displacement member 8 extends in a direction away from the rotation shaft 90 (shaft hole 81 shown in FIG. 3) of the holder 9, and the groove width of the groove 80 gradually expands as the groove 80 moves away from the rotation shaft 90.

More specifically, a lower slide surface 80b (see FIG. 4A) of the displacement member 8 is a plane extending linearly in a direction substantially perpendicular to the axial direction of the rotation shaft 90 (substantially parallel to the arrow F-B direction in FIG. 4A). On the other hand, an upper slide surface 80a is formed by a plane parallel to the lower slide surface 80b, an inclined surface rising upward to the front side from the front edge (the end on the arrow F side) of the plane portion, and a curved surface smoothly connecting the plane and the inclined surface.

An opening of the groove 80 is formed on the outer peripheral surface of the displacement member 8 by the front edge of the inclined surface of the upper slide surface 80a and the front edge of the lower slide surface 80b. The guide pin 73 of the linkage member 7 is inserted through the opening along an insertion direction C. The insertion direction C of the guide pin 73 is the same direction as the sliding direction of the guide pin 73 along the groove 80 (where the upper and lower slide surfaces 80a, 80b face each other in parallel).

In the displacement member 8, a regulation wall 84 connecting the inclined surface of the upper slide surface 80a and the front end portion of the lower slide surface 80b is formed at the opening portion of the groove 80. The regulation wall 84 is a wall for regulating the guide pin 73 of the linkage member 7 from coming out of the groove 80. While not shown herein, in the assembled state of the white key 2a (the state shown in FIG. 1) where the guide pin 73 is engaged with the groove 80, the regulation wall 84 is disposed at a position overlapping with the guide pin 73 in the insertion direction C of the guide pin 73.

Therefore, in the state where the white key 2a is pivotally supported by the key shaft member 5 (see FIG. 1), if the guide pin 73 is simply inserted from the opening of the groove 80 along the insertion direction C, the insertion may interfere with the regulation wall 84. Such interference can be largely avoided by the swinging of the displacement member 8 as indicated by arrow B in FIG. 3. However, in the embodiment, a front inclined surface 84a (see FIG. 4A) is formed on the side surface of the regulation wall 84 to facilitate the insertion of the guide pin 73 into the groove 80 more easily. The side surface of the regulation wall 84 refers to a surface facing the side (the front side in the direction perpendicular to the paper surface in FIG. 4A) opposite to the protrusion direction of the guide pin 73 in the scale direction.

The front inclined surface 84a is inclined to obliquely cut out the front edge portion of the side surface of the regulation wall 84. Therefore, at the time of inserting the guide pin 73 from the opening of the groove 80 along the insertion direction C, by slightly causing the oscillation of the displacement member 8 as indicated by arrow B in FIG. 3 (slightly twisting the displacement member 8 toward the back side in the direction perpendicular to the paper surface in FIG. 4A), the guide pin 73 can be engaged in the groove 80 while sliding along the front inclined surface 84a. As a result, the guide pin 73 can be easily engaged in the groove 80, thereby improving the workability of the assembly process of the white key 2a.

In addition, a rear inclined surface 84b is also formed on the side surface of the regulation wall 84. The rear inclined surface 84b is inclined to obliquely cut out the rear edge (the end on the arrow B side) portion of the side surface of the regulation wall 84. Therefore, at the time of pulling out the guide pin 73 from the groove 80 in the direction opposite to the insertion direction C, by slightly swinging the displacement member 8 as indicated by arrow B in FIG. 3 (slightly twisting the displacement member 8 toward the back side in the direction perpendicular to the paper surface in FIG. 4A), the guide pin 73 can be removed from the groove 80 while sliding along the rear inclined surface 84b. As a result, the guide pin 73 can be easily removed from the groove 80, thereby improving the workability of replacement and maintenance operations of the white key 2a.

Here, as shown in FIG. 4B, in the state where the guide pin 73 is not engaged in the groove 80, the displacement member 8 rotates around the rotation shaft 90 due to its own weight.

When the displacement member 8 contacts the coil 100 on the substrate 10 due to the rotation, there is a risk that the coil 100 may be damaged.

If the detected part 82 of the displacement member 8 is formed in one arc shape centered on the rotation shaft 90, even if the displacement member 8 rotates around the rotation shaft 90 due to its own weight, the detected part 82 does not contact the coil 100. However, as will be described in detail later, the detected part 82 of the embodiment is formed by a curved surface part 82a in an arc shape centered on the rotation shaft 90, and a plane part 82b in a line shape connected to the front edge of the curved surface part 82a. Therefore, in the case where the guide pin 73 is removed from the groove 80, if the displacement member 8 rotates around the rotation shaft 90 due to its own weight, there is a risk that the plane part 82b of the detected part 82 may contact the coil 100.

In contrast, the embodiment has a configuration that can prevent such contact between the plane part 82b and the coil 100. Specifically, a convex part 85 protrudes from the side surface of the displacement member 8, the convex part 85 surrounding the groove 80 (upper and lower slide surfaces 80a, 80b), and the wall part 91 (attached part 92) of the holder 9 is formed on the displacement trajectory around the rotation shaft 90. The configuration is such that in the case where the displacement member 8 rotates around the rotation shaft 90 due to its own weight, the wall part 91 (attached part 92) of the holder 9 contacts the convex part 85 at the contact point P1 before the plane part 82b of the detected part 82 contacts the coil 100.

Additionally, the configuration is such that simultaneously with the contact between the wall part 91 and the convex part 85 at the contact point P1, the connection part 95 of the holder 9 also contacts the displacement member 8 at a contact point P2. In other words, a portion of the holder 9 (the wall part 91, the attached part 92, and the connection part 95) positioned on the displacement trajectory of the displacement member 8 functions as a regulation member that regulates the contact between the detected part 82 (plane part 82b) and the coil 100.

As a result, even in the case where the detected part 82 is not in one arc shape centered on the rotation shaft 90 (for example, when the plane part 82b is formed), the holder 9 can regulate the contact between the detected part 82 and the coil 100 when the displacement member 8 rotates around the rotation shaft 90 due to its own weight. Therefore, damage to the coil 100 due to such contact can be prevented.

Next, referring to FIG. 5 and FIG. 6, the attachment structure of the substrate 10 will be described. FIG. 5 is an exploded perspective view of the keyboard device 1 showing the state where the substrate 10 and the fixed member 11 are removed. FIG. 6A is a side view of the keyboard device 1 as viewed in the direction of arrow VIa in FIG. 5, and FIG. 6B is a side view of the keyboard device 1 showing the process of mounting the substrate 10 to the holder 9 and the fixed member 11. FIG. 6A illustrates the state where the fixed member 11 is fixed to the support part 41 of the chassis 4.

As shown in FIG. 5, a pair of protrusions 110 arranged in the scale direction (arrow L-R direction) protrude from the upper surface of the fixed member 11, and through holes 44 are formed in the support part 41 of the chassis 4 at positions corresponding to the protrusions 110. By inserting the pair of protrusions 110 into the through holes 44, the attachment position of the fixed member 11 relative to the support part 41 is determined.

On the rear side with respect to the pair of protrusions 110, a through hole 111 is formed to penetrate through the fixed member 11 in the upper-lower direction. The fixed member 11 is attached to the lower surface of the support part 41 by inserting a screw (not shown) from below into the through hole 111 and fastening the screw to a threaded hole 45 of the support part 41 of the chassis 4.

From the front surface (the surface facing the arrow F side) of the fixed member 11, a fixed part 112 for fixing the substrate 10 protrudes toward the front side, and a threaded hole 113 extending in the upper-lower direction is formed in the fixed part 112. Multiple fixed members 11 are arranged in the scale direction, and through holes 101 are formed at positions corresponding to the threaded holes 113 of the fixed members 11 on the rear end side (the end on the arrow B side) of the substrate 10. The rear end of the substrate 10 is fixed to the fixed member 11 by inserting screws (not shown) from below into the through holes 101 of the substrate 10 and fastening the screws to the threaded holes 113 of the fixed members 11.

As shown in FIG. 6A, a protrusion 96 protrudes downward from the lower surface of the hanging part 94 of the holder 9, and a protrusion 97 protrudes rearward from the rear surface (the surface facing the arrow B side) of the connection part 95. The respective protrusions 96, 97 are integrally formed with the hanging part 94 and the connection part 95. While not shown, the respective protrusions 96, 97 are arranged in the scale direction.

An inclined surface 96a inclined upward toward the front upper side is formed on the front edge (the end on the arrow F side) of the protrusion 96, and an inclined surface 97a inclined downward toward the rear lower side is formed on the rear edge (the end on the arrow B side) of the protrusion 97. The respective inclined surfaces 96a, 97a are formed parallel to each other. The interval between the inclined surfaces 96a and 97a, and the interval between the lower surface of the protrusion 96 and the upper surface of the protrusion 97 are substantially the same as the thickness of the substrate 10.

As shown in FIG. 6B, at the time of attaching the substrate 10 to the holder 9 and the fixed member 11, firstly, the substrate 10 is inserted between the respective protrusions 96, 97 in a state where the substrate 10 is inclined to be parallel to each inclined surface 96a, 97a. Then, as indicated by arrow D, the front end of the substrate 10 is rotated between the respective protrusions 96, 97, and the rear end of the substrate 10 is screwed to the fixed member 11. As a result, the substrate 10 is supported on the support part 41 of the chassis 4 via the holder 9 and the fixed member 11.

In this way, in the embodiment, the substrate 10 is supported on the holder 9 by inserting the front end of the substrate 10 between the respective protrusions 96, 97 (insertion part). In other words, the substrate 10 is merely inserted between the protrusions 96, 97 without being screwed to the holder 9, so the need for forming through holes (such as through holes 101) for screwing to the holder 9 in the front end portion of the substrate 10 can be eliminated. Accordingly, the front-rear direction dimension of the substrate 10 can be shortened, and the manufacturing cost of the substrate 10 can be reduced.

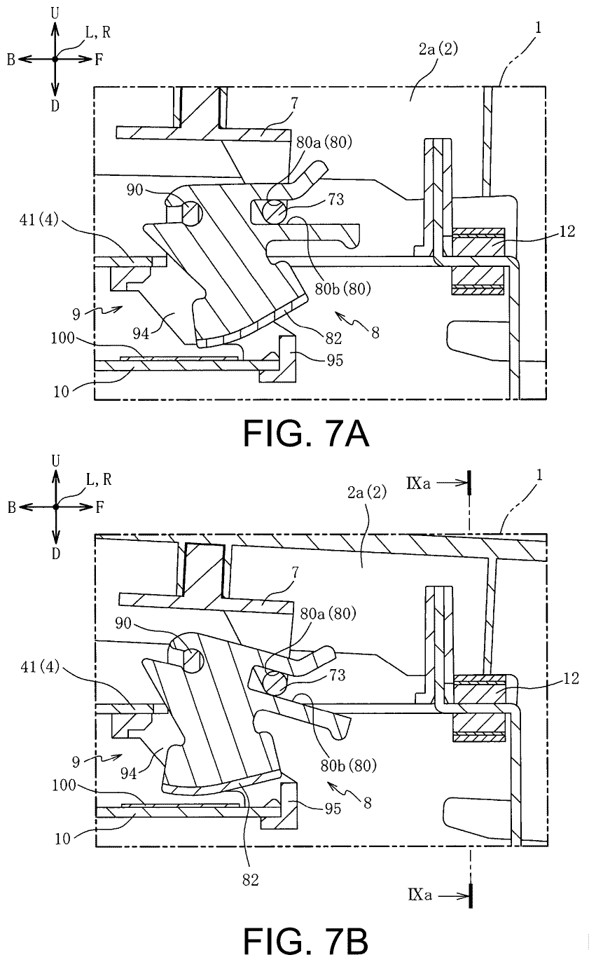

Next, referring to FIGS. 7A and 7B, the operation of the displacement member 8 associated with the pressing (releasing) of the white key 2a will be described. FIG. 7A is a partially enlarged cross-sectional view of the keyboard device 1 showing a state during key-pressing (before the white key 2a contacts the key-pressing stopper 12) from the state shown in FIG. 1, and FIG. 7B is a partially enlarged cross-sectional view of the keyboard device 1 showing a state where the white key 2a, further pressed from the state in FIG. 7A, has come into contact with the key-pressing stopper 12.

As shown in FIGS. 7A and 7B, at the time when the white key 2a is pressed, the guide pin 73 rotates downward (clockwise in FIGS. 7A and 7B). At this time, the lower slide surface 80b is pushed in by the guide pin 73. As a result, the displacement member 8 rotates around the rotation shaft 90 of the holder 9 (clockwise in FIGS. 7A and 7B).

Together with the rotation, the detected part 82 of the displacement member 8 relatively displaces with respect to the substrate 10 supported by the holder 9. In other words, as the stroke length of the white key 2a increases from the state before key-pressing, the penetration amount of the detected part 82 into the detection region increases. The penetration amount of the detected part 82 refers to the size of the area where the detected part 82 and the coil 100 face each other in the thickness direction (upper-lower direction) of the substrate 10.

Meanwhile, in the case where the white key 2a is released after being pressed, the guide pin 73 rotates (counterclockwise in FIGS. 7A and 7B) to return to the static position due to the elastic force of the coil spring 6 (see FIG. 1). Through the rotation of the guide pin 73, the upper slide surface 80a of the groove 80 is pushed up by the guide pin 73, so that the displacement member 8 rotates around the rotation shaft 90 (counterclockwise in FIGS. 7A and 7B). At this time, the penetration amount of the detected part 82 into the detection region decreases.

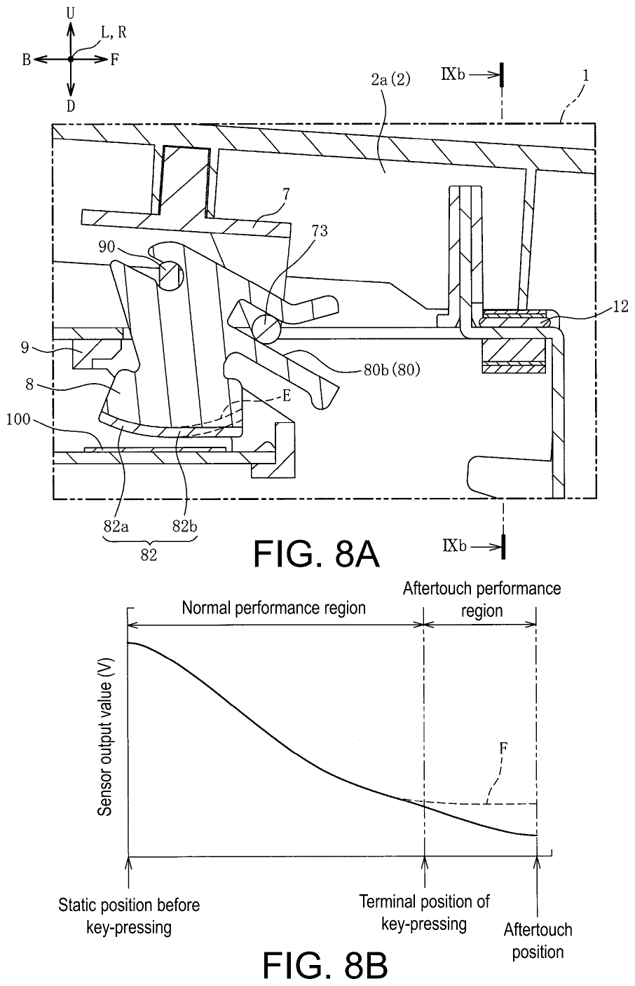

The detected part 82 is formed using a non-magnetic metal (such as copper). Therefore, in a state where a magnetic field is generated by flowing a current through the coil 100, as the penetration amount of the detected part 82 into the detection region increases, the inductance of the coil 100 decreases, and as the penetration amount of the detected part 82 into the detection region decreases, the inductance of the coil 100 increases. Based on this increase and decrease in the inductance of the coil 100, the sensor output value (V) changes (see FIG. 8B). The key-pressing information (note information) is detected based on the increase/decrease in the sensor output value.

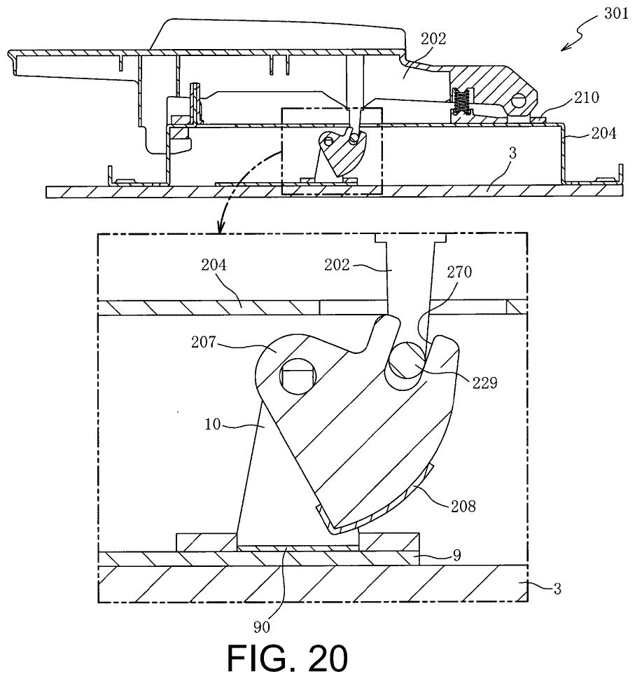

Regarding the technology for detecting key-pressing information by using such non-contact sensor, the applicant of the invention has filed a patent application for the invention shown in FIG. 20 (PCT/JP2022/032673, which was unpublished at the time of filing this application). FIG. 20 is a cross-sectional view of a conventional keyboard device 301.

In the conventional keyboard device 301, an issue arises where the static position (angle) of the displacement member 207 before key-pressing, or the displacement amount (rotation amount) of the displacement member 207 together with key-pressing may deviate from the design value.

As a reason why such issue occurs, in the structure shown in FIG. 20, while the holder 210 that rotatably supports the key 202 is fixed to the chassis 204, the holder 10 that rotatably supports the displacement member 207 is fixed to the base plate 3 via the substrate 9. In other words, because the key 202 and the displacement member 207 are assembled to different components, the relative positional accuracy between the key 202 and the displacement member 207 tends to decrease due to assembly errors, etc. As a result, the engagement position between a guide pin 229 of the key 202 and a groove 270 of the displacement member 207 tend to easily deviate from the design value.

Comparatively, in the embodiment, as shown in FIGS. 7A and 7B, the structure includes the chassis 4 (first support member), the white key 2a (multiple keys 2) pivotally supported by the chassis 4, the displacement member 8 that moves in conjunction with the swinging of the white key 2a, the holder 9 (second support member) that supports the displacement member 8 in a displaceable manner and is attached to the chassis 4, and the coil 100 (sensor) that faces the detected part 82 of the displacement member 8 and detects the displacement of the displacement member 8.

In other words, because the white key 2a and the holder 9 to which the displacement member 8 is pivotally supported are assembled to the same chassis 4, the relative positional accuracy between the white key 2a and the displacement member 8 can be improved. As a result, the guide pin 73 of the linkage member 7 and the groove 80 of the displacement member 8 can be accurately engaged at the position as designed. Therefore, the static position (angle) of the displacement member 8 before key-pressing and the displacement amount (rotation amount) of the displacement member 8 accompanying key-pressing are more likely to follow the design value. Consequently, the key-pressing information of the white key 2a can be detected with high accuracy.

Moreover, at the static position before key-pressing (the state shown in FIG. 1), the lower slide surface 80b of the groove 80 is inclined upward towards the upper front side. When the displacement member 8 rotates until an angle where the lower slide surface 80b is along the horizontal direction at the time of key-pressing, the guide pin 73 slides toward the rear end side (arrow B side) of the lower slide surface 80b (see FIG. 1 and FIG. 7A). On the other hand, at the time when the displacement member 8 rotates further from the angle where the lower slide surface 80b is along the horizontal direction at the time of key-pressing, the guide pin 73 slides towards the front end side (arrow F side) of the lower slide surface 80b (see FIG. 7A and FIG. 7B).

That is, because the sliding direction of the guide pin 73 along the groove 80 reverses midway through key-pressing (the guide pin 73 moves back and forth in the groove 80 at the time of key-pressing), the sliding range of the guide pin 73 relative to the groove 80 can be narrowed. As a result, the groove 80 can be formed shorter, so the shape accuracy of the groove 80 is increased easily. Accordingly, it becomes easier for the engagement position of the guide pin 73 and the groove 80 to conform to the design value. Therefore, the key-pressing information of the white key 2a can be accurately detected.

Additionally, since the substrate 10 is directly attached to the holder 9 to which the displacement member 8 is pivotally supported, the relative position accuracy between the displacement member 8 and the coil 100 on the substrate 10 can also be improved. As a result, the clearance between the coil 100 and the detected part 82 of the displacement member 8 is more likely to conform to the dimensions in accordance with the design values. Therefore, the key-pressing information of the white key 2a can be accurately detected.

In the embodiment, the substrate 10 is directly attached to the holder 9, but it may also be configured that the substrate 10 is attached to a support component provided separately from the holder 9. As an example of the configuration, a structure as follows is shown: the hanging part 94 and the connection part 95 of the holder 9 are omitted, the substrate 10 is extended toward the front side (arrow F side), and the front end portion of the substrate 10 is supported by a component similar to the fixed member 11 (see FIG. 6). Even in such a structure, because the substrate 10 on which the coil 100 is provided and the holder 9 to which the displacement member 8 is pivotally supported can be supported on the same chassis 4, the clearance between the coil 100 and the detected part 82 is more likely to conform to the dimensions according to the design values. Consequently, the key-pressing information of the white key 2a can be detected with high accuracy.

Here, it is possible to integrally form the key shaft member 5 (see FIG. 2) that supports the white key 2a to be swingable, or the fixed member 11 (see FIG. 6) to which the rear end of the substrate 10 is fixed, with the holder 9. However, if the components are integrally formed, the components become larger, making it easier for errors to occur in the dimensions of the components themselves (for example, in the length in the front-rear direction). When such dimensional errors occur, the engagement position of the guide pin 73 and the groove 80, or the clearance between the detected part 82 and the coil 100 becomes more likely to deviate from the design value. Consequently, the key-pressing information of the white key 2a cannot be detected with high accuracy.

Comparatively, in the embodiment, because the key shaft member 5 (see FIG. 2), the holder 9, and the fixed member 11 are separate components, each of the components can be miniaturized. As a result, the dimensional accuracy of the key shaft member 5, the holder 9, and the fixed member 11 themselves is more likely to improve.

Also, while not shown, the key shaft member 5 (see FIG. 2) pivotally supports keys 2 for one octave, and as mentioned above, the holder 9 pivotally supports displacement members 8 for one octave (12 pieces) (see FIG. 3).

That is, multiple key shaft members 5 and holders 9 are arranged in the scale direction. Accordingly, compared to a configuration where all the keys 2 arranged in the scale direction are pivotally supported by one key shaft member 5, or a configuration where all displacement members 8 arranged in the same direction are pivotally supported by one holder 9, the key shaft member 5 and the holder 9 can be miniaturized. Therefore, the dimensional accuracy of the key shaft member 5 or the holder 9 themselves is easily improved.

Also, as mentioned above, because the fixed members 11 (see FIG. 6) are also arranged in the scale direction, the fixed members 11 can be made smaller than the case where the substrate 10 is supported by one fixed member 11 extending in the scale direction. As a result, the dimensional accuracy of the fixed member 11 itself is more likely to improve.

In this way, by improving the dimensional accuracy of the key shaft member 5, the holder 9, and the fixed member 11 themselves, the engagement position of the guide pin 73 and the groove 80, or the clearance between the detected part 82 and the coil 100, is more likely to conform to the design value. Consequently, the key-pressing information of the white key 2a can be detected with high accuracy.

As shown in FIG. 7B, the swinging of the white key 2a at the time of being pressed is regulated by the key-pressing stopper 12. The key-pressing stopper 12 is a cushioning material adhered to the upper surface on the front end side of the support part 41 of the chassis 4, and the region until the lower surface of the white key 2a contacts the key-pressing stopper 12 at the time of key-pressing is the normal performance region. Meanwhile, the performance that presses the key deeper than the terminal position of normal performance (the state shown in FIG. 7B where the white key 2a is in contact with the key-pressing stopper 12, hereinafter referred to as “terminal position of key-pressing”) is the aftertouch performance region. When the aftertouch performance is executed, effects (changes in volume or vibrato) are added to the musical sound of normal performance.

In the embodiment, in addition to the key-pressing information during normal performance, the key-pressing information at the time of aftertouch performance is also detected based on a change in the magnetic field of the coil 100 (increase or decrease in sensor output value). The detection method for such performance will be described with reference to FIGS. 7A and 7B and FIGS. 8A and 8B.

FIG. 8A is a partially enlarged cross-sectional view of the keyboard device 1 showing a state where the white key 2a is further pushed in from the state shown in FIG. 7B, and FIG. 8B is a graph showing a relationship between the stroke length of the white key 2a and the sensor output value, where the vertical axis indicates the magnitude (V) of the sensor output value, and the horizontal axis indicates the stroke length of the key 2 of the white key 2a. In FIG. 8B, for ease of understanding, the range of the aftertouch performance region and the change in sensor output value are schematically illustrated.

As shown in FIG. 8A, when the white key 2a is further pushed in from the terminal position of key-pressing (the state in FIG. 7B), the key-pressing stopper 12 is compressed by the white key 2a, while the lower slide surface 80b of the groove 80 is pushed downward by the guide pin 73 of the linkage member 7. As a result, the penetration amount of the detected part 82 into the detection region further increases.

As shown in FIG. 8B, as the penetration amount of the detected part 82 into the detection region facing the coil 100 increases, the sensor output value decreases. That is, at the time of pressing the white key 2a, the sensor output value gradually decreases as the push-in amount of the white key 2a increases. Meanwhile, at the time of releasing the white key 2a, the sensor output value gradually increases.

To accurately detect the key-pressing information based on the sensor output value, the difference (hereinafter referred to as “dynamic range”) between the sensor output value before key-pressing and the sensor output value at the terminal position of key-pressing may be large. In particular, in the embodiment, in addition to normal performance, it is also configured to detect aftertouch performance from the change in sensor output value shown in FIG. 8B. Therefore, to accurately detect aftertouch, it is necessary to significantly decrease the sensor output value when the white key 2a in contact with the key-pressing stopper 12 is further pushed in.

The sensor output value decreases as the area where the coil 100 and the detected part 82 face each other increases, and also decreases as the distance between the coil 100 and the detected part 82 decreases. Therefore, for example, when the detected part 82 is formed in one arc shape centered on the rotation shaft 90 of the holder 9, as shown by a broken line E in FIG. 8A, the distance between the detected part 82 and the coil 100 at the time when the displacement member 8 rotates till the aftertouch performance region cannot be sufficiently close. Consequently, as shown by a broken line F in FIG. 8B, it becomes difficult for the sensor output value to decrease in the aftertouch performance region.

In other words, in the case where the detected part 82 is formed in one arc shape centered on the rotation shaft 90 of the holder 9, it becomes difficult to expand the dynamic range, so aftertouch cannot be accurately detected. Moreover, when the size of the displacement member 8 (coil 100) increases to expand the dynamic range, issues such as an increase in size and cost of the keyboard device 1 arise.

Comparatively, in the embodiment, by providing the curved surface part 82a and the plane part 82b in the detected part 82, a configuration that can accurately detect aftertouch is achieved. The configuration will be described below. In the following description regarding the detected part 82, the rotation direction of the displacement member 8 is used as a reference, with the direction in which the displacement member 8 rotates at the time of key-pressing is referred to as the front side of the detected part 82, and the opposite side is referred to as the rear side.

In the detected part 82, the part positioned on the front side (arrow B side) in the rotation direction of the displacement member 8 is the curved surface part 82a, and the part continuous with the rear side of the curved surface part 82a in the same rotation direction is the plane part 82b. The curved surface part 82a is formed in an arc shape (a curved shape convex in a direction away from the rotation shaft 90) centered on the rotation shaft 90, and the plane part 82b is formed in a plate shape extending in the tangential direction of the rear end (the end on the arrow F side) of the curved surface part 82a.

That is, since the curvature of the plane part 82b is smaller than that of the curved surface part 82a, it is possible for the distance between the coil 100 and the detected part 82 (plane part 82b) to be short in the aftertouch performance region than the case where the detected part 82 is one arc shape centered on the rotation shaft 90 as described above. Accordingly, the dynamic range can expand (with a significantly decrease in the sensor output value in the aftertouch performance region) without enlarging the displacement member 8 (coil 100). That is, it is possible to accurately detect aftertouch while miniaturizing the displacement member 8.

In particular, in the embodiment, since the plane part 82b is formed in a plate shape, it is possible for the distance between the coil 100 and the detected part 82 (plane part 82b) to be as short as possible in the aftertouch performance region than the case where the plane part 82b is a curved surface with a smaller curvature than that of the curved surface part 82a. Therefore, the dynamic range can be effectively expanded.

Furthermore, at the terminal position of the aftertouch performance region (the position where the effect due to aftertouch becomes maximum, hereinafter referred to as the “maximum aftertouch position”), the plane part 82b and the coil 100 (substrate 10) face each other to be substantially in parallel, so it is possible for the distance between the coil 100 and the detected part 82 (plane part 82b) as close as possible. In this way as well, the dynamic range can be effectively expanded. It should be noted that, although “substantially parallel” preferably refers to a state where the plane part 82b and the coil 100 (substrate 10) face each other to be in parallel without contacting each other, but the expression may also refer to that the plane part 82b and the coil 100 face each other to be non-parallel.

In this way, by expanding the dynamic range of the sensor output value, the key-pressing information of the white key 2a can be detected with high accuracy. Particularly, in the case where aftertouch is detected based on a change in the sensor output value, as in the embodiment, it is especially preferable to have a wide dynamic range (where the sensor output value significantly decreases in the aftertouch performance region). Accordingly, aftertouch can be accurately detected.

In the embodiment, at the static position before key-pressing (see the enlarged portion in FIG. 1), the curved surface part 82a of the detected part 82 and the coil 100 are disposed at overlapped positions in the vertical direction (thickness direction of the substrate 10). In other words, because the curved surface part 82a of the detected part 82 and the coil 100 face each other in the upper-lower direction at the static position before key-pressing, changes in the sensor output value associated with the rotation of the detected part 82 can be generated immediately after key-pressing. Accordingly, the key-pressing information can be accurately detected.

Here, as a conventional technology for detecting aftertouch, a technique is known where a pressure sensor is pushed by a hammer that moves in conjunction with the swinging of the key at the time of key-pressing (for example, Japanese Patent Application Laid-Open Publication No. H08-234751). In such type of keyboard device, if the key-pressing stopper that regulates the swinging of the key at the time of key-pressing is formed to be relatively rigid, the sensation of reaching the end of normal performance (hereinafter referred to as “full stroke feel”) is more easily imparted to the performer when the key contacts the stopper at the time of key-pressing.

However, if the key-pressing stopper is formed to be rigid, it becomes difficult to significantly displace the key (hammer) during aftertouch performance. Therefore, aftertouch cannot be easily detected. Meanwhile, if the key-pressing stopper is simply formed to be soft, it is difficult to obtain the full stroke feel when the key contacts the key-pressing stopper, so the performer performing normal performance may push the key into the aftertouch region. Therefore, normal performance and aftertouch cannot be accurately distinguished. In response thereto, the key-pressing stopper 12 of the embodiment has a configuration that can solve such problems.

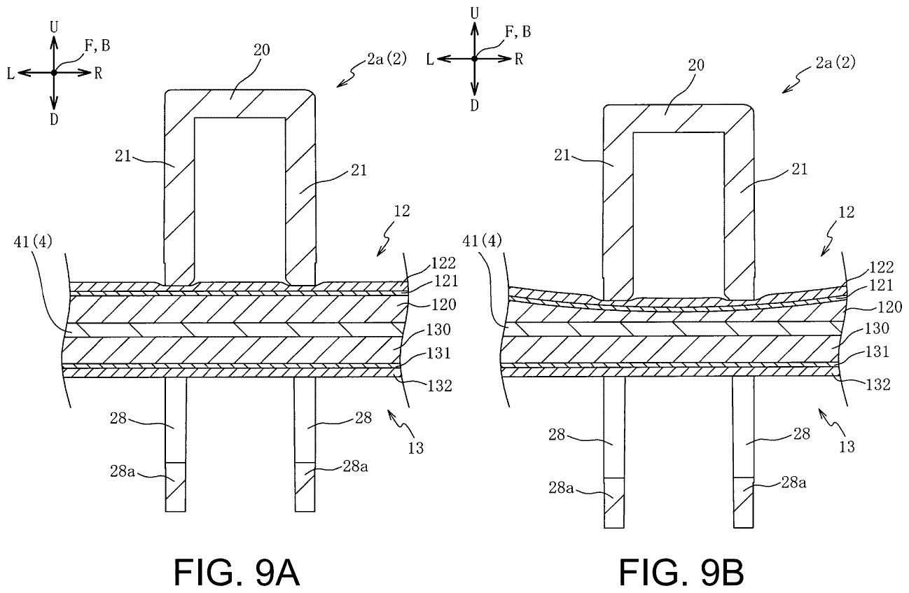

The detailed configuration of the key-pressing stopper 12 will be described with reference to FIG. 9A and FIG. 9B. FIG. 9A is a partially enlarged cross-sectional view of the keyboard device 1 along a line IXa-IXa in FIG. 7B, showing a cross-sectional view of the state where the white key 2a has swung to the terminal position of key-pressing. FIG. 9B is a partially enlarged cross-sectional view of the keyboard device 1 along a line IXb-IXb in FIG. 8A, showing a cross-sectional view of the state where the white key 2a has been further pushed (aftertouch performance has been executed) from the state in FIG. 9A. It should be noted that FIG. 9 illustrates only the essential parts of the keyboard device 1, omitting the illustration of other parts (for example, the keys 2 adjacent to the white key 2a).

As shown in FIG. 9, the key-pressing stopper 12 includes a first cushion layer 120 made of foam urethane adhered to the upper surface of the support part 41 of the chassis 4 by using a double-sided tape or adhesive. On the surface layer side (on the side of the side plate 21 of the white key 2a) of the first cushion layer 120, a rigid layer 121 made of PET (polyethylene terephthalate) is laminated. Furthermore, on the surface layer side of the rigid layer 121, a second cushion layer 122 made of felt is laminated, and the layers 120 to 122 are adhered to each other by using an adhesive or a double-sided tape.

In this manner, in the embodiment, the rigid layer 121, which is more rigid than the first cushion layer 120, is laminated on the surface layer side of the relatively soft first cushion layer 120. Accordingly, as shown in FIG. 9A, in the case where the pair of side plates 21 of the white key 2a contact the key-pressing stopper 12 (second cushion layer 122) at the time of key-pressing, a relatively rigid full stroke feel can be imparted to the performer by the rigid layer 121.

Furthermore, even if the rigid layer 121 is pushed towards the side of the first cushion layer 120 by using the pair of side plates 21 during normal performance, the first cushion layer 120 is compressed as a whole by the relatively rigid layer 121 (the pushing force of the white key 2a is distributed by the rigid layer 121), so a relatively small pressure applied to the first cushion layer 120. As a result, even if the first cushion layer 120 is relatively soft, it is possible to suppress the white key 2a from being pushed into the aftertouch performance region. Therefore, key-pressing intended for normal performance can be suppressed from being detected as aftertouch.

Meanwhile, as shown in FIG. 9B, at the time when the rigid layer 121 is strongly pushed during aftertouch performance, the white key 2a can be significantly displaced due to the deformation of the relatively soft first cushion layer 120. Therefore, aftertouch can be detected with high accuracy. In other words, normal performance and aftertouch can be accurately distinguished and detected.

Furthermore, even if the key-pressing stopper 12 is strongly pushed by the pair of side plates 21, the rigid layer 121 deforms to bend, so the load due to the pushing is distributed by the rigid layer 121. That is, the rigid layer 121 can regulate the deformation of the pair of side plates 21 in a way that prevents them from digging into the first cushion layer 120, thereby improving the durability of the key-pressing stopper 12 (making the first cushion layer 120 less likely to become compressed).

Additionally, the key-pressing stopper 12 is formed in a linear shape extending in the scale direction (arrow L-R direction), and the swinging of multiple keys 2 (for example, the keys 2 for one octave) arranged in the scale direction is regulated by one key-pressing stopper 12. As a result, even if the key-pressing stopper 12 is strongly pushed in by the pair of side plates 21, the pushing force can be effectively distributed by the bending of the rigid layer 121 extending in the scale direction. Therefore, the durability of the key-pressing stopper 12 can be improved.

By improving the durability of the key-pressing stopper 12, it is possible to suppress the reduction of the thickness of the key-pressing stopper 12 over time, thereby suppressing the gradual deepening of the terminal position of key-pressing. Therefore, key-pressing intended for normal performance can be suppressed from being detected as aftertouch, so normal performance and aftertouch can be accurately distinguished and detected.

As described above, in the embodiment, it is configured that, in addition to aftertouch, the key-pressing information at the time of normal performance until contact with the key-pressing stopper 12 is also detected based on the output value of the coil 100. In other words, since it is configured that normal performance and aftertouch are detected by one sensor, in such a configuration, it is particularly preferable to regulate the displacement of the white key 2a by using the key-pressing stopper 12 including the respective layers 120-122. Accordingly, normal performance and aftertouch can be accurately distinguished.

However, even in a keyboard device where the sensor (keyboard switch 4) for detecting key-pressing information during normal performance and the sensor (pressure sensor 5) for detecting aftertouch are separate sensors, as in the conventional technique (e.g., Japanese Patent Application Laid-Open Publication No. H08-234751), the swinging of the keys may also be regulated by using the key-pressing stopper 12 of the embodiment.

Here, in the case where the purpose is simply to impart a full stroke feel for normal performance by using the rigid layer 121 alone while allowing a large displacement of the white key 2a through the deformation of the first cushion layer 120 during aftertouch performance, it is possible to omit the second cushion layer 122. However, when the white key 2a comes into contact with the relatively rigid (for example, made of PET) rigid layer 121, noise due to this contact is likely to occur.

Therefore, as in the embodiment, the second cushion layer 122, which is softer than the rigid layer 121, may be laminated on the surface layer side of the rigid layer 121. Accordingly, the impact when the pair of side plates 21 come into contact with the key-pressing stopper 12 can be absorbed by using the second cushion layer 122. Therefore, the noise generated at the time of the contact can be reduced.

On the other hand, the first cushion layer 120 is softer than the second cushion layer 122. Accordingly, it is possible to reduce the noise generated at the time when the white key 2a (side plate 21) comes into contact with the key-pressing stopper 12 by using the second cushion layer 122, while the white key 2a can be significantly displaced through the deformation of the first cushion layer 120 during the aftertouch performance.

The thickness of the first cushion layer 120 is between 1.5 mm or more and 8.0 mm or less, and the thickness of the rigid layer 121 is between 0.1 mm or more and 0.5 mm or less. Additionally, the thickness of the second cushion layer 122 is 1.0 mm or more and 3.0 mm or less.

That is, since the thickness of the rigid layer 121 is less than the thickness of the first cushion layer 120, it is possible to impart the full stroke feel for normal performance by using the rigid layer 121, whereas the white key 2a can be significantly displaced through the deformation of the first cushion layer 120 during aftertouch performance.

Furthermore, the thickness of the second cushion layer 122 is greater than the thickness of the rigid layer 121 and less than the thickness of the first cushion layer 120. Accordingly, when the full stroke feel for normal performance is imparted by using the rigid layer 121, it is possible to reduce the noise at the time when the white key 2a (the side plate 21) and the second cushion layer 122 come into contact, whereas the white key 2a can be significantly displaced through the deformation of the first cushion layer 120 at the time of aftertouch performance.

A stopper part 28 is integrally formed on the side plate 21 of the white key 2a to regulate the swinging of the white key 2a at the time of key release. The stopper part 28 extends downward from the side plate 21, and a bending part 28a that bends toward the rear side (the front side in the direction perpendicular to the paper surface in FIG. 9) is formed at the lower end of the stopper part 28.

The bending part 28a is hooked onto the lower surface of the support part 41 through a through hole 46 formed in the front leg part 40 of the chassis 4 (see FIG. 5), and a key-releasing stopper 13 facing the bending part 28a in the upper-lower direction is adhered to the lower surface of the support part 41 of the chassis 4.

In the key-releasing stopper 13, a first cushion layer 130, a rigid layer 131, and a second cushion layer 132 are laminated in this order from the side of the support part 41 of the chassis 4. The respective layers 130 to 132 have the same configuration as the respective layers 120 to 122 of the key-pressing stopper 12.

Therefore, although not illustrated, even when the key-releasing stopper 13 is pushed in by the bending parts 28a of the pair of stopper parts 28 during the key-release of the white key 2a, the rigid layer 131 that is relatively rigid causes the first cushion layer 130 to be compressed as a whole (the pushing force of the white key 2a is distributed by the rigid layer 131), so the pressure applied to the first cushion layer 130 can be reduced. In other words, since the rigid layer 131 can regulate the deformation of the pair of bending parts 28a from digging into the first cushion layer 130, the durability of the key-releasing stopper 13 can be improved.

Furthermore, the key-releasing stopper 13 is formed in a linear shape extending in the scale direction, and the swinging of multiple keys 2 (for example, keys 2 for one octave) arranged in the scale direction at the time of key release is regulated by one key-releasing stopper 13. Accordingly, the pushing force by the pair of bending parts 28a can be effectively distributed by the deflection of the rigid layer 131 extending in the scale direction. Therefore, the durability of the key-releasing stopper 13 can be improved.

By improving the durability of the key-releasing stopper 13, the gradual thickness reduction of the key-releasing stopper 13 over time can be suppressed. Therefore, the gradual increase in the height of the white key 2a at the static position can be suppressed. Consequently, it is possible to suppress the occurrence of height variation among the respective keys 2 placed in the static position, so the appearance of the keyboard device 1 can be improved.

Furthermore, by maintaining the height of the white key 2a at the static position before key-pressing to be constant, it is possible to suppress the deviation of the engagement position between the guide pin 73 (see the enlarged portion in FIG. 1) and the groove 80 from the design value. Consequently, the key-pressing information of the white key 2a can be accurately detected based on the displacement of the displacement member 8 (change in sensor output value).

In this way, by regulating the swinging of the white key 2a with each stopper 12, 13 having a laminated structure, the height of the white key 2a at the static position before key-pressing or at the terminal position of key-pressing becomes less likely to change over time. However, it is difficult to completely eliminate the change (that is, aging) in the static position or the terminal position of key-pressing of the white key 2a over time.

For example, if the static position of the white key 2a changes over time, a difference occurs between the height of the static position of the white key 2a determined from the sensor output value and the actual height of the white key 2a at the static position. In such a state where the difference occurs, the actual movement of the white key 2a cannot be detected accurately from the sensor output value.

In response thereto, for example, Japanese Patent Application Laid-Open Publication No. 2010-197910 discloses a technology that corrects the static position to the current position of a key in the case where the static state of the key continues for a predetermined time or longer, and the current position (height) of the key is at a height equal to or greater than a predetermined height. According to the technology, even in the case where the height of the key at the static position changes over time, key-pressing information can be detected based on the height of the key after such change.

However, the key-pressing information of a key is detected based on the behavior of the sensor output value from the static position of the key to the terminal position of key-pressing. Therefore, with a configuration that corrects only the static position of the key, as in the conventional technology, it is still not possible to accurately detect the key-pressing information.

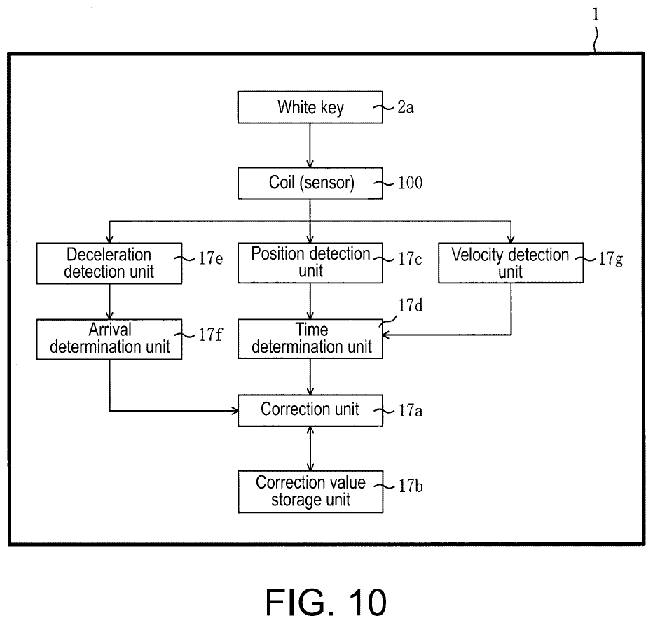

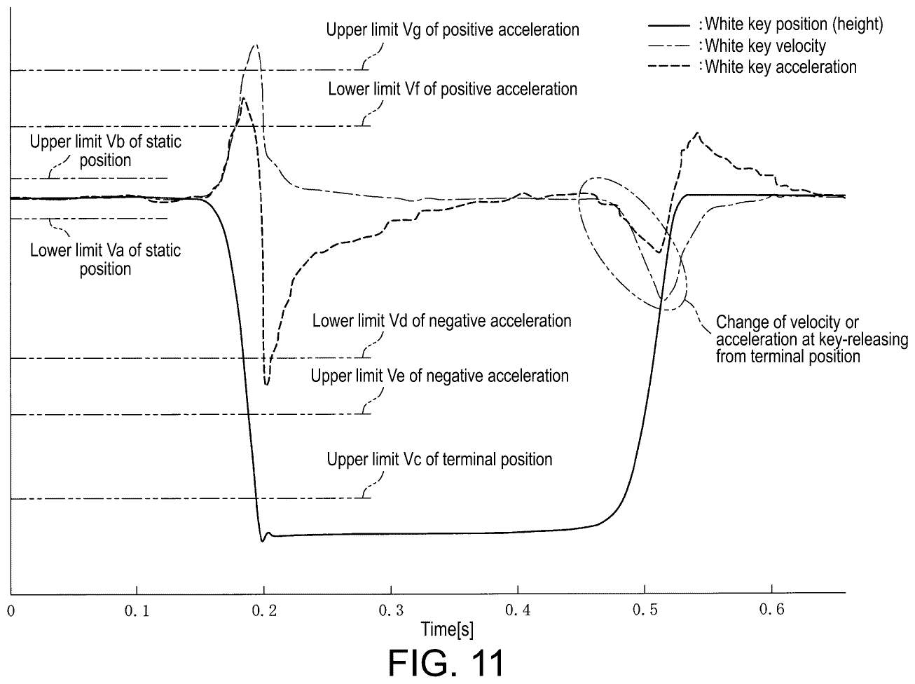

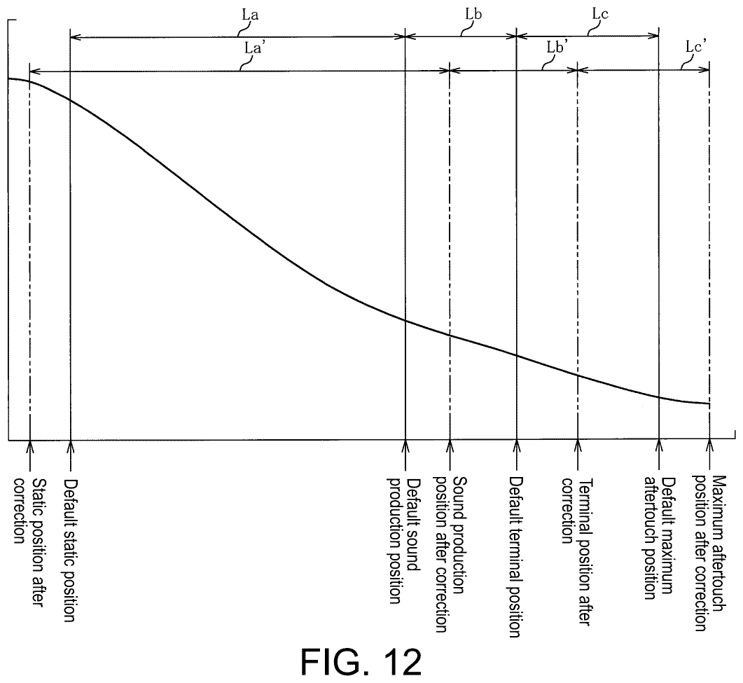

Therefore, in the embodiment, for detecting key-pressing information more accurately, the sensor output values at the respective positions of the white key 2a, including the static position, the terminal position of key-pressing (normal performance), and the maximum aftertouch position, are corrected (calibrated), and the key-pressing information for normal performance and aftertouch is then detected based on the correction values. The outline of the correction method for each position of the white key 2a will be described with reference to FIGS. 10 to 12. FIG. 10 is a functional block diagram of the keyboard device 1, FIG. 11 is a graph showing the time variations of the position (height), velocity, and acceleration of the white key 2a when normal key-pressing is performed, and FIG. 12 is a graph showing the relationship between the stroke length of the white key 2a and the sensor output value, which indicates the relationship between each position such as the static position of the white key 2a and the sound production position.

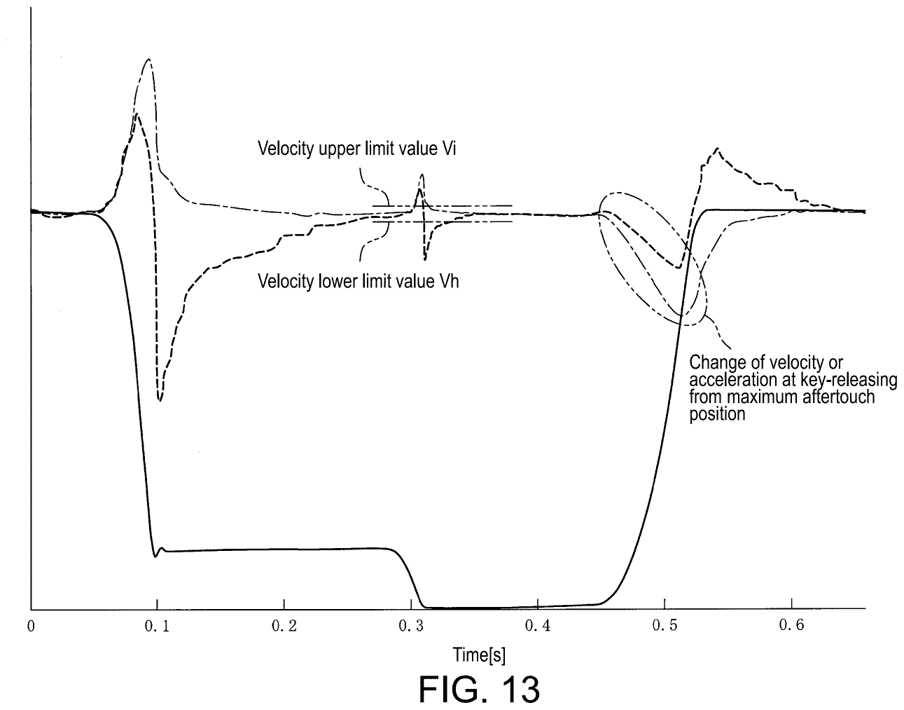

In FIG. 11, the solid line indicates the time variation of the position of the white key 2a, the dash-dot line indicates the time variation of the velocity of the white key 2a, and the broken line indicates the time variation of the acceleration of the white key 2a. For the velocity and acceleration of the white key 2a, the magnitude is shown for the case where the key-pressing direction is positive (the same applies to FIG. 13 to be described afterwards).

As shown in FIG. 10, the position of the white key 2a (key 2) of the keyboard device 1 is detected by the coil (sensor) 10, and based on the output value of the coil 100, each position of the white key 2a is corrected by the correction unit 17a. The correction values obtained by using the correction unit 17a are stored in the correction value storage unit 17b.

As shown in FIGS. 10 and 11, at the time of correcting the static position of the white key 2a, firstly, to determine whether the white key 2a has returned to the static position, the position detection unit 17c (see FIG. 10) verifies whether the height (sensor output value) of the white key 2a is equal to or greater than a lower limit value Va (first static threshold) of the static position (see FIG. 11). The lower limit value Va can be set arbitrarily, but, for example, in the case where the stroke length from the default static position to the default terminal position set at the time of factory shipment of the keyboard device 1 is L, a configuration is exemplified where the position at a distance (height) of 0.7 L to 0.9 L from the default terminal position is set as the lower limit value Va of the static position.

In addition to the lower limit value Va, it is also possible to set an upper limit value Vb (second static threshold) of the static position. For example, it may be determined whether the white key 2a has returned to the static position based on whether the distance from the default terminal position to the current position (height) of the white key 2a is 0.9 L or more and 1.1 L or less, or whether the distance from the default terminal position to the current position of the white key 2a is between 0.7 L or more and 1.3 L or less.

Next, the time determination unit 17d (see FIG. 10) determines, for example, whether the current position of the white key 2a is equal to or greater than the lower limit value Va of the static position, and whether the state where the white key 2a is static (the state where the height of the white key 2a is higher than the lower limit value Va of the static position) has continued for a predetermined time. Then, in the case where the time determination unit 17d determines that the static state of the white key 2a has continued for the predetermined time, the correction unit 17a corrects the sensor output value indicating the static position of the white key 2a based on the height (sensor output value) of the white key 2a at this time.

An example for the case where the correction of the sensor output value at the static position is performed is illustrated in FIG. 12. The example shows a case where the static position of the white key 2a is corrected to a position higher (shallower) than the default static position (left side in FIG. 12). By performing such correction, even in the case where the static position of the white key 2a has changed (for example, become higher) due to factors such as deterioration of the key-releasing stopper 13, it is possible to accurately determine whether the white key 2a is positioned at the static position.

Next, an overview of the correction of the terminal position of key-pressing is described. As shown in FIG. 10 and FIG. 11, the correction of the terminal position of key-pressing is performed in the case where the current position of the white key 2a is equal to or lower than the upper limit value Vc (terminal threshold) of the terminal position (see FIG. 11). Accordingly, since the movements of the white keys 2a that have not been pressed to the terminal position are excluded from the correction condition, the terminal position can be suppressed from being set to an excessively high (shallow) position. While the upper limit value Vc of the terminal position can also be set arbitrarily, a configuration is exemplified where a position where the distance from the default static position of the white key 2a set at the time of factory shipment of the keyboard device 1 is 0.7 L to 0.9 L is set as the upper limit value Vc of the terminal position.

In the case where the current position of the white key 2a is equal to or lower than the upper limit value Vc of the terminal position, the deceleration detection unit 17e (see FIG. 10) detects whether the magnitude of the negative acceleration (deceleration) generated when the white key 2a contacts the key-pressing stopper 12 is equal to or greater than a predetermined lower limit value Vd (first deceleration threshold) (see FIG. 11). Then, in the case where the deceleration detected by the deceleration detection unit 17e is equal to or greater than the lower limit value Vd, the arrival determination unit 17f (see FIG. 10) determines that the white key 2a has reached the terminal position of key-pressing. In the case where this arrival condition is satisfied, the correction unit 17a corrects the terminal position of key-pressing as the position of the white key 2a at the time of arrival (the sensor output value at that position).

An example for the case where the correction of the sensor output value at the terminal position is performed is illustrated in FIG. 12. The example shows a case where the terminal position of the white key 2a is corrected to a position lower (deeper) than the default terminal position (right side in FIG. 12). By performing such correction of the sensor output value, even in the case where the terminal position of key-pressing has changed (for example, become deeper) due to factors such as deterioration of the key-pressing stopper 12, whether the white key 2a has reached the terminal position of key-pressing can be accurately determined.

In addition, as shown in FIG. 11, the arrival determination unit 17f determines that the white key 2a has reached the terminal position of key-pressing in the case where the magnitude of the negative acceleration of the white key 2a is equal to or less than a predetermined upper limit value Ve (second deceleration threshold). In other words, in the case where the magnitude of the negative acceleration of the white key 2a exceeds the upper limit value Ve, the correction of the terminal position (sensor output value) by the correction unit 17a is not performed. Therefore, excessively strong key presses of the white key 2a from the target of terminal position correction can be excluded.

Furthermore, the arrival determination unit 17f determines that the white key 2a has reached the terminal position of key-pressing in the case where the magnitude of the positive acceleration (velocity, or physical quantity indicating the strength of key-pressing may also be used) of the white key 2a immediately before reaching the terminal position is equal to or greater than a predetermined lower limit value Vf (first pre-arrival threshold). Accordingly, excessively weak key presses of the white key 2a can be excluded from the target of terminal position correction. In this way, by correcting the terminal position only in the case where the white key 2a is pressed with moderate strength, the terminal position of key-pressing can be appropriately corrected to a suitable position (height).

Instead of only determining whether the magnitude of the positive acceleration of the white key 2a immediately before reaching the terminal position is equal to or greater than the predetermined lower limit value Vf (first pre-arrival threshold), it may also be determined whether the magnitude of the positive acceleration (velocity or physical quantity indicating the strength of key-pressing may also be used) is equal to or greater than a predetermined upper limit value Vg (second pre-arrival threshold). In such case, by correcting the terminal position in the case where the acceleration is equal to or less than the upper limit value Vg, excessively strong key presses of the white key 2a can be excluded from the target of terminal position correction.

Next, an overview of the correction method for the maximum aftertouch position will be described with reference to FIGS. 10, 12, and 13. FIG. 13 is a graph showing the time variation of the position, the velocity, and the acceleration of the white key 2a when aftertouch is performed following a normal key press.

As shown in FIGS. 10 and 13, at the time of correcting the maximum aftertouch position, first, a velocity detection unit 17g (see FIG. 10) detects whether the velocity (or acceleration) of the white key 2a is in a low-velocity state that is equal to or greater than a predetermined lower limit value Vh and equal to or less than an upper limit value Vi (see FIG. 13). In the case where the time determination unit 17d determines that such low-velocity state of the white key 2a has continued for a predetermined time, the current maximum aftertouch position stored in the correction value storage unit 17b (see FIG. 10) is compared with the current position of the white key 2a. Then, in the case where the current position of the white key 2a is lower than the current maximum aftertouch position, the correction unit 17a corrects the position of the white key 2a at such time (the sensor output value at that position) to the maximum aftertouch position.

An example of the case where the correction of the sensor output value at the maximum aftertouch position is performed is illustrated in FIG. 12. The example shows a case where the maximum aftertouch position of the white key 2a is corrected to a position lower (deeper) than a default maximum aftertouch position. By performing such correction of the maximum aftertouch position, even in the case where the maximum aftertouch position has changed (for example, become deeper) due to factors such as deterioration of the key-pressing stopper 12, whether the white key 2a has reached the maximum aftertouch position can be accurately determined.

In this way, by performing correction of the sensor output values at each of the static position, the terminal position of key-pressing, and the maximum aftertouch position of the white key 2a, it is possible to increase the consistency between the sensor output value indicating (distinguishing) that the white key 2a is positioned at each of the positions and the actual position of the white key 2a. Therefore, the key-pressing information of the white key 2a can be detected with high accuracy, enabling, for example, accurate differentiation and detection between normal performance and aftertouch. The relationship between each position of the white key 2a before and after such correction and the sound production position at the time of key-pressing of the white key 2a will be described with reference to FIG. 12.

As shown in FIG. 12, the stroke length of the white key 2a from the default static position set at the time of factory shipment of the keyboard device 1 to the default sound production position is defined as La, the stroke length of the white key 2a from the default sound production position to the default terminal position is defined as Lb, and the stroke length from the default terminal position to the default maximum aftertouch position is defined as Lc.

The sound production position is the position where the instruction for generating (producing) normal performance sound is carried out based on the key-pressing information of the white key 2a from the static position to the sound production position. Additionally, the maximum aftertouch position is the position where the effect due to aftertouch becomes maximum when the white key 2a reaches such position. In other words, the application due to the aftertouch effect begins from a position between the terminal position of key-pressing and the maximum aftertouch position, and the effect applied to the musical sound changes (for example, gradually increases) from the start position to the maximum aftertouch position.

At the time of factory shipment of the keyboard device 1, the stroke ratio (Lb/La) between the stroke length La from the static position to the sound production position and the stroke length Lb from the sound production position to the terminal position is set to approximately 3:1 (Lb/La=⅓). That is, in the case where the stroke length L (L=La+Lb) for normal performance from the default static position to the default terminal position is defined, the sound production position is set at a position 0.2 L to 0.3 L from the terminal position.

Due to the correction of each position of the white key 2a as described above, for example, in the case where the terminal position of key-pressing is corrected to a lower (deeper) position (right side in FIG. 12) than the default value, the stroke length of the white key 2a from the default sound production position to the corrected terminal position becomes longer. Therefore, in the embodiment, in order to bring the stroke length of the white key 2a from the sound production position to the corrected terminal position to be closer to the state at the time of factory shipment, a correction is performed to shift the sound production position toward the terminal position side.

More specifically, the correction of the sound production position is performed to bring a stroke ratio (Lb′/La′) between a stroke length La′ of the white key 2a from the corrected static position to the corrected sound production position and a stroke length Lb′ of the white key 2a from the corrected sound production position to the corrected terminal position closer to the default stroke ratio (Lb/La) at the time of factory shipment. As a result, even if the height of the white key 2a at each position changes due to deterioration of the key-pressing stopper 12 or the key-releasing stopper 13, and the like, the performance feel of the keyboard device 1 can be maintained to be constant before and after such change. Therefore, the performer can be provided with a good performance feel.

In addition, in the case where a stroke length from the corrected terminal position to the corrected maximum aftertouch position is defined as Lc′, the correction amount of the terminal position or the maximum aftertouch position may also be adjusted to maintain the corrected stroke length Lc′ at an appropriate length. As an example of the adjustment method, for example, at the time of performing the correction of the terminal position or the maximum aftertouch position of key-pressing, a configuration is exemplified where the correction amount of the terminal position or the maximum aftertouch position is adjusted so that the difference between the stroke length Lc from the default terminal position to the maximum aftertouch position and the stroke length Lc′ from the corrected (current) terminal position to the maximum aftertouch position falls within a predetermined range.

Furthermore, although the correction (calibration) of the sensor output values at the respective positions of the white key 2a described above describes a correction method for the case where the sensor output value decreases at the time of key-pressing (as the stroke length of the white key 2a increases), it is possible to make a similar correction in the case where the sensor output value increases at the time of key-pressing. For example, in the case where the sensor output value increases at the time of key-pressing, it suffices as long as correction is made to determine that the sensor output value is at the static position before key-pressing if it can be determined from the time variation of the sensor output value that the sensor output value is lower than the lower limit value of the static position. Additionally, it suffices as long as the correction is made to determine that the value when the sensor output value becomes the highest is the maximum aftertouch position.

In the embodiment, as described above, a configuration determines that the white key 2a has reached the terminal position in the case where the magnitude of the negative acceleration of the white key 2a at the time of key-pressing becomes equal to or greater than the predetermined lower limit value Vd. Comparatively, for example, as shown in the portion enclosed by a two-dot chain line in FIG. 11, it is also possible to determine whether the white key 2a has reached (or had reached) the terminal position based on the change (i.e., the magnitude of negative velocity or acceleration when the key-pressing direction is defined as positive) in velocity or acceleration at the time when the key is released from the terminal position.

However, since the keyboard device 1 of the embodiment includes an aftertouch performance function, if the determination method is employed, as shown in the portion enclosed by the two-dot chain line in FIG. 13, the terminal position may be corrected based on the negative velocity or acceleration when the key is released from the maximum aftertouch position. Therefore, there is a risk that the terminal position of key-pressing may be corrected to an excessively lower (deeper) position.

Therefore, in the case where the keyboard device 1 has the aftertouch performance function as in the embodiment, the terminal position may be corrected based on the negative acceleration that occurs at the time of key-pressing. Accordingly, the terminal position of key-pressing can be accurately corrected.

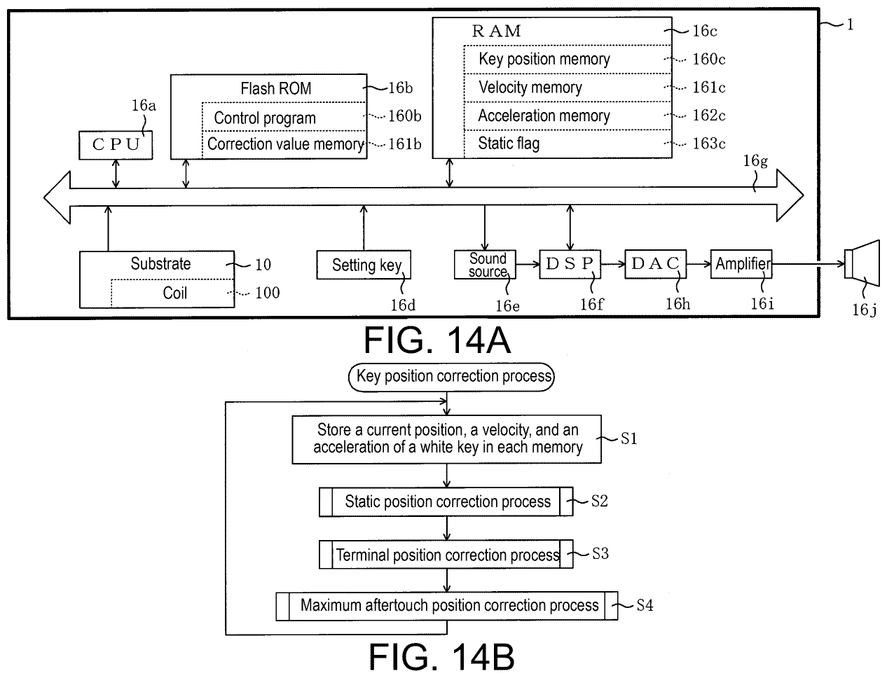

Next, referring to FIG. 14A and 14B, the electrical configuration of the keyboard device 1 and the correction process for the key position will be described. FIG. 14A is a block diagram showing the electrical configuration of the keyboard device 1, and FIG. 14B is a flowchart of the correction process for the key position.

As shown in FIG. 14A, the keyboard device 1 includes the substrate 10 (coil 100), a CPU 16a, a flash ROM 16b, a RAM 16c, a setting key 16d, a sound source 16e, and a digital signal processor (DSP) 16f. The respective configurations are connected via a bus line 16g.

The CPU 16a is a computational device that controls each unit connected via the bus line 16g. The flash ROM 16b is a rewritable non-volatile storage device that stores programs executed by the CPU 16a and fixed value data, etc., and stores a control program 160b and a correction value memory 161b forming the correction value storage unit 17b (see FIG. 10). When the control program 160b is executed by the CPU 16a, the correction process for the key position shown in FIG. 14B is executed.

The correction value memory 161b stores, as default values (initial values), the sensor output values (values detected by the coil 100) indicating where the white key 2a is positioned at each of the static position, the terminal position of key-pressing, and the maximum aftertouch position. The default values in the correction value memory 161b are set in advance at the time of factory shipment of the keyboard device 1.

The default values stored in the correction value memory 161b are corrected (updated) through the correction process (S2 to S4) for each position of the white key 2a, which will be described later. However, the default values and the correction values for the respective positions of the white key 2a (values from one or multiple times in the past) are stored as history in the correction value memory 161b. The correction values stored in the correction value memory 161b may be one value for all the keys 2, one value for each key range (for example, 12 keys), or one value for each key 2.

The RAM 16c is a memory for the CPU 16a to rewritably store various work data and flags during program execution. The RAM 16c includes a key position memory 160c, a velocity memory 161c, an acceleration memory 162c, and a static flag 163c, which are used in the correction process (S2 to S4) for each position of the white key 2a.

The key position memory 160c stores the history of time changes of the positions (heights) of the white key 2a determined from the sensor output values. The velocity memory 161c stores the history of time changes of the velocity of the white key 2a calculated based on the sensor output values (time changes of the positions of the white key 2a), and the acceleration memory 162c stores the history of time changes of the acceleration of the white key 2a calculated based on the sensor output values (time changes of the positions or velocities of the white key 2a). The static flag 163c is a flag for determining whether the white key 2a is in the static state.

The setting key 16d is a key for the performer to make various settings such as the performance mode, etc., in the keyboard device, and examples include switches provided on the housing of the keyboard device 1 or operation keys displayed on a touch panel. The sound source 16e is a device that outputs waveform data based on the key-pressing information (note information) of the white key 2a, and the DSP 16f is a computational device for performing computing processing on the waveform data input from the sound source 16e.

The DSP 16f is connected to a digital-to-analog converter (DAC) 16h. In the DAC 16h, the musical sound signal processed by the DSP 16f is converted into an analog signal. The DAC 16h is connected to a speaker 16j through an amplifier 16i, the analog signal output from the DAC 16h is amplified by the amplifier 16i, and the musical sound based on the signal is emitted from the speaker 16j.

As shown in FIG. 14B, in the key position correction process, firstly, the position of the white key 2a at the current time point (hereinafter referred to as “current position of the white key 2a”), the velocity and acceleration are stored in the respective memories 160c to 162c (S1), and the static position correction process (S2) of the white key 2a is executed. After executing the static position correction process (S2) of the white key 2a, the terminal position correction process (S3) of key-pressing and the correction process (S4) for the maximum aftertouch position are executed in order, and then the flow returns to the process of S1.

Although the correction process for the key position is automatically executed when power is supplied to the keyboard device 1 (during the performance of the keyboard device 1 by the performer), the invention is not limited thereto. For example, the key position correction process may be executed in the case where the performer switches to “correction mode” by operating the setting key 16d.

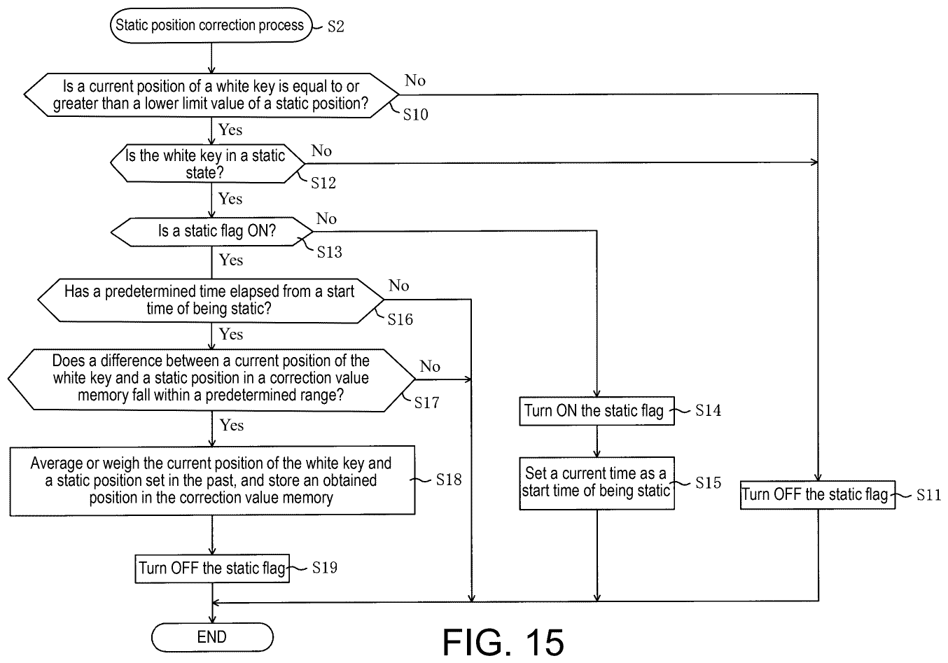

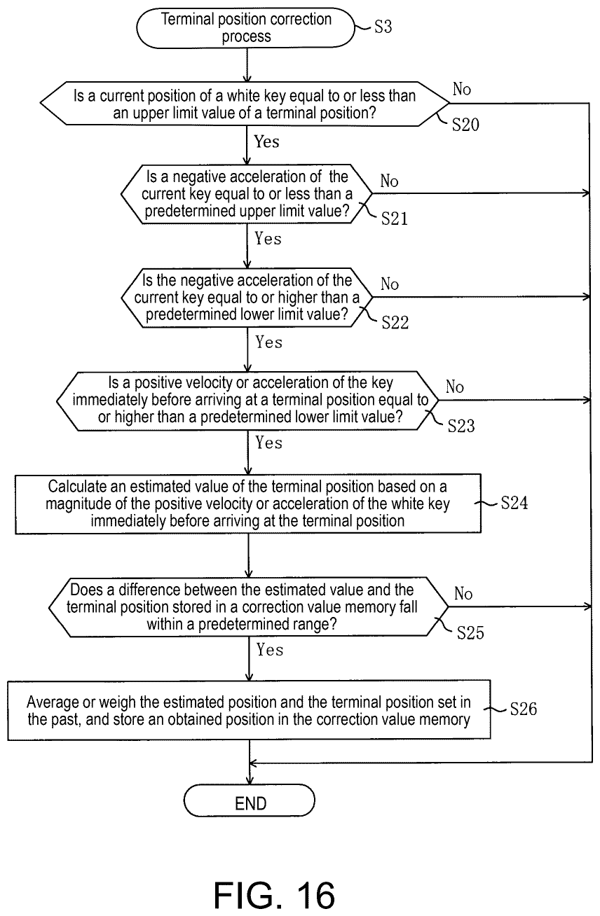

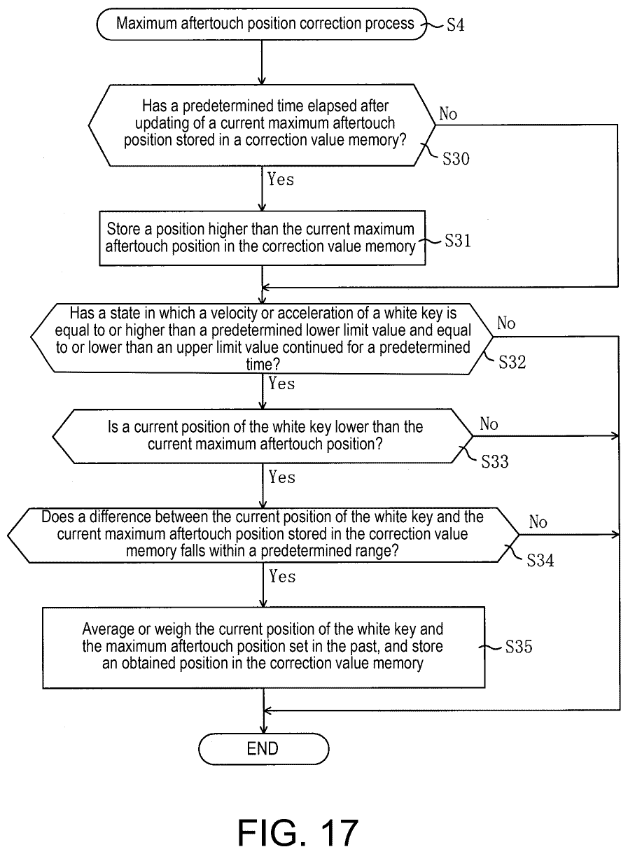

Then, referring to FIGS. 15 to 17, the details of the correction process for each position of the white key 2a will be described. FIG. 15 is a flowchart of the correction process for the static position, FIG. 16 is a flowchart of the correction process for the terminal position, and FIG. 17 is a flowchart of the correction process for the maximum aftertouch position.

As shown in FIG. 15, in the correction process for the static position of the white key 2a, firstly, the current position of the white key 2a is obtained from the key position memory 160c, and whether the current position is equal to or greater than the lower limit value Va of the static position of the white key 2a is verified (S10). The case where the current position of the white key 2a is lower than the lower limit value Va of the static position (S10: No), for example, indicates a state where the white key 2a is pressed by the performer. In such case, the static flag 163c is turned off (S11), and the series of processes is ended.

Meanwhile, in the process of S10, in the case where the current position of the white key 2a is equal to or greater than the lower limit value Va of the static position (S10: Yes), it is estimated that the white key 2a has returned to the static position. Therefore, the key position memory 160c (the velocity memory 161c or the acceleration memory 162c) is referenced to verify whether the white key 2a is in a static state (S12). In the case where the white key 2a is not in the static state (S12: No), for example, since the white key 2a is in a pressed state, the static flag 163c is turned off (S11), and the series of processes is ended without correcting the static position.

On the other hand, in the process of S12, in the case where the white key 2a is in the static state (S12: Yes), whether the static flag 163c is turned on is verified (S13). In the case where the static flag 163c is not turned on (S13: No), in order to verify whether the white key 2a is stably static at the static position, the static flag 163c is turned on (S14), and the current time is set as the static start time (S15), and then the series of processes is ended.

Meanwhile, in the process of S13, in the case where the static flag 163c is turned on, it is in a state where the white key 2a has started being static, so whether a predetermined time has elapsed from the start time is verified (S16). In the case where the predetermined time has not elapsed since the start of the static state (S16: No), the series of processes is ended. Meanwhile, in the case where the predetermined time has elapsed (S16: Yes), it can be estimated that the current position of the white key 2a is the static position.

Therefore, in the case where the static time of the white key 2a has exceeded the predetermined time (S16: Yes), whether the difference between the current position of the white key 2a and the current static position stored in the correction value memory 161b falls within a predetermined range is verified (S17). In the case where the difference is outside the predetermined range (the difference is too large) (S17: No), the series of processes is ended without correcting the static position of the white key 2a, because the static position of the white key 2a stored in the correction value memory 161b changes significantly.

Meanwhile, in the case where the difference in S17 falls within the predetermined range (S18: Yes), the correction value memory 161b is referenced, and based on the current position of the white key 2a and the static position of the white key 2a corrected in the past (correction value stored in the correction value memory 161b), a position obtained by averaging such values or a position obtained by weighted calculation is stored in the correction value memory 161b as the correction value of the static position of the white key 2a (S18).

As an example of the process in S18, for example, in the case where the correction of the static position has been performed N times in the past before the correction at the current time, the sum of the correction values in the past (or the current position of the white key 2a at the time of determining whether to perform the correction) and the current position of the white key 2a at the current time are added together, and the average obtained by dividing the sum by N+1 is used as the correction value.

That is, the value calculated from “(sum of correction values from N times in the past+current position of white key 2a this time)/(N+1)” is stored in the correction value memory 161b as the correction value of the static position of the white key 2a. In this way, with the configuration in which the correction value is set as the average of the correction values of N times in the past and the current position of the white key 2a at the current time, the correction of the static position of the white key 2a can be performed gradually.

As another example of the process in S18, the correction value memory 161b is referenced to obtain the correction value of the static position of the previous time (i.e., the static position of the white key 2a set at the current time), and the correction value so obtained and a weighting coefficient P are used to calculate the correction value for the static position at the current time.

Specifically, for example, if the value of the weighting coefficient P is set to 0.01 (1%), the value calculated by “(correction value of the static position at the previous time)×(1−P)+current position of white key 2a at this time×P” is used as the correction value of the static position at the current time, and is stored in the correction value memory 161b. In this way, in the configuration that uses the weighting coefficient P to correct the static position of the white key 2a as well, the correction of the static position of the white key 2a can also be performed gradually.

In this way, according to the processes in S17 and S18, the static position of the white key 2a can be corrected gradually. In other words, since large fluctuations of the static position of the white key 2a stored in the correction value memory 161b can be suppressed, extreme changes in the performance feel of the keyboard device 1 can be suppressed. Therefore, the performer can be provided with a good performance feel.

After performing the correction of the static position of the white key 2a in the process of S18, the static flag 163c is turned off (S19), and the series of processes is ended. Following the execution of the static position correction process (S2), the terminal position correction process (S3) shown in FIG. 16 is executed.

As shown in FIG. 16, in the terminal position correction process (S3), first, the current position of the white key 2a is obtained from the key position memory 160c, and whether that current position is equal to or lower than the upper limit value Vc of the terminal position of key-pressing (S20).

In the case where the current position of the white key 2a exceeds the upper limit value Vc of the terminal position of key-pressing (S20: No), the series of processes is ended without performing the correction of the terminal position. With the process in S20, for example, even in the case where the white key 2a is released before reaching the terminal position (during key-pressing), the correction of the terminal position based on that key release is not performed, so it is possible to suppress the terminal position from being excessively corrected to a lower (shallower) position.

On the other hand, in the process of S20, in the case where the current position of the white key 2a is equal to or below the upper limit value Vc of the terminal position of key-pressing

(S20: Yes), the acceleration memory 162c is referenced to verify whether the magnitude of the current negative acceleration (deceleration) of the white key 2a is equal to or below the predetermined upper limit value Ve (first deceleration threshold) (S21). In the case where the magnitude of the negative acceleration of the white key 2a exceeds the predetermined upper limit value Ve (S21: No), there is a high possibility that the white key 2a is excessively pushed against the stopper 12, so the series of processes is ended without performing the correction of the terminal position. With the process in S21, it is possible to suppress the terminal position from being excessively corrected to a lower (deeper) position due to an excessively strong key-pressing of the white key 2a.

Meanwhile, in the process of S21, in the case where the current negative acceleration of the white key 2a is equal to or below the predetermined upper limit value Ve (S21: Yes), whether the same acceleration is equal to or above the predetermined lower limit value Vd is verified (S22). In the case where the current negative acceleration of the white key 2a is below the predetermined lower limit value Vd (S22: No), the key-pressing of the white key 2a is weak, so the series of processes is ended without performing the correction of the terminal position.

Meanwhile, in the process of S22, if the current negative acceleration of the white key 2a is equal to or above the predetermined lower limit value Vd (S22: Yes), it can be estimated that the white key 2a pressed with moderate strength has reached the terminal position. In the embodiment, whether the estimation is correct is further determined strictly by the process of S23.

In the process of S23, in the case where it is estimated that the white key 2a has reached the terminal position in the process of S22, the velocity memory 161c or the acceleration memory 162c is referenced, and whether the magnitude of the positive velocity or acceleration of the white key 2a immediately before reaching the terminal position is equal to or above the predetermined lower limit value Vf is verified. In the case where the velocity or acceleration is below the predetermined lower limit value Vf (S23: No), it can be determined that the key-pressing of the white key 2a is weak, so the series of processes is ended without correcting the terminal position.

As mentioned above, in addition to the process of S23, the configuration may also be that the flow proceeds to S24 and subsequent processes in the case where the magnitude of the positive velocity or acceleration of the white key 2a immediately before reaching the terminal position is equal to or below the predetermined upper limit value Vg.

By excluding excessively strong key-pressing or excessively weak key-pressing of the white key 2a from the conditions for performing correction of the terminal position, as in the processes of S21 to 23, the terminal position of key-pressing can be suppressed from being excessively corrected to a lower position or a higher position.

Meanwhile, in the process of S23, in the case where the magnitude of the positive velocity or acceleration of the white key 2a immediately before reaching the terminal position is equal to or above the predetermined lower limit value Vf (S23: Yes), the white key 2a is being pressed with moderate strength. In such case, an estimated value of the terminal position reached by the white key 2a is calculated in the process of S24.

Specifically, in the process of S24, based on the magnitude of the velocity or acceleration of the white key 2a immediately before reaching the terminal position, the estimated value of the terminal position reached by the white key 2a is calculated. By estimating the terminal position from the magnitude of the velocity or acceleration of the white key 2a before reaching the terminal position, the terminal position can be corrected to an appropriate position according to the strength of the key-pressing.

The estimated value can be obtained by adjusting (subtracting or adding) “the current position (height) of the white key 2a at the time when it is estimated to have reached the terminal position” with “a value calculated from an equation of the velocity V or the acceleration a” in the case where V is set as the velocity of the white key 2a immediately before reaching the terminal position and a is set as the acceleration. For example, the equation of motion for the velocity V can be expressed as a quadratic function such as “aV\hat{ }2+bV+c”, and the coefficients a, b, and c of the quadratic function are determined in advance through experimentation during the development stage.

Then, in the case of a relatively weak key-pressing that satisfies the reaching condition for the terminal position (S20-S23: Yes), a position “lower (deeper) than the current position of the white key 2a at the time when the reaching condition is established” is set as the estimated value of the terminal position. On the other hand, in the case of a relatively strong key-pressing that satisfies the reaching condition, a position “higher (shallower) than the current position of the white key 2a at the time when the reaching condition is established” is set as the estimated value of the terminal position. By correcting the terminal position using the estimated value, the correction value of the terminal position can be made to be consistently close to a constant value regardless of the strength of the key-pressing. Therefore, the terminal position of the key-pressing can be corrected to an appropriate position.

After calculating the estimated value of the terminal position in the process of S24, whether the difference between the estimated value and the current terminal position stored in the correction value memory 161b falls within a predetermined range is verified (S25). In the case where the difference falls outside the predetermined range (the difference is too large) (S25: No), the series of processes is ended without correcting the terminal position. With the process of S25, it is possible to suppress large fluctuations in the terminal position stored in the correction value memory 161b, thereby suppressing extreme changes in the performance feel of the keyboard device 1.

Meanwhile, in the case where the difference in S25 falls within the predetermined range (S25: Yes), the correction value memory 161b is referenced, and a position obtained by averaging the calculated estimated value and the terminal position set in the past (correction value stored in the correction value memory 161b), or a position obtained by weighted calculation, is stored in the correction value memory 161b as the correction value for the terminal position of the key-pressing (S26).

In the process of S26, the calculation same as the process of S18 is performed. That is, in the process of S26, the correction value of the terminal position is determined by the calculation method of “((sum of correction values of terminal positions of N times in the past)+(estimated value of terminal position at the current time))/(N+1)” or “((correction value of terminal position at the last time)×(1−P))+(estimated value of terminal position at the current time)×P (for example, P=0.01)”. Accordingly, the terminal position of the key-pressing can be gradually corrected.

After performing the correction of the terminal position of the key-pressing in the process of S26, the series of processes is ended. Following the execution of the terminal position correction process (S3), the maximum aftertouch position correction process (S4) shown in FIG. 17 is executed.

As shown in FIG. 17, in the maximum aftertouch position correction process (S4), firstly, whether a predetermined time (update time) has elapsed since the current maximum aftertouch position stored in the correction value memory 161b is updated (corrected) (S30) is verified. The judgment on the elapsed time in S30 may be based on actual time, or whether the number of times that the white key 2a has been pressed has reached a predetermined number or more may be counted.

That is, the process of S30 determines whether it is a time period in which the maximum aftertouch position is supposed to be updated, and, for example, in the case where a predetermined time has not elapsed since the correction of the maximum aftertouch position is performed (S30: No), the process of S31 is skipped and the flow proceeds to S32.

Meanwhile, in the case where the predetermined time has elapsed since the correction of the maximum aftertouch position is performed in the process of S30 (S30: Yes), a position higher than the current maximum aftertouch position is stored in the correction value memory 161b as a new maximum aftertouch position (S31). According to the process of S31, even in the case where the maximum aftertouch position has been excessively corrected to a lower (deeper) position, it is possible to restore the maximum aftertouch position to a higher (shallower) position. Therefore, it is possible to suppress the inability of imparting the maximum effect of aftertouch performance.

In the embodiment, it is configured that the processes of S30 and S31 are repeatedly performed after the power of the keyboard device 1 is turned on. However, the invention is not limited thereto. For example, it may also be configured to perform the process of S31 once (omitting the process of S30) every time when the power of the keyboard device 1 is turned on. Also, it may also be configured that the process of S31 is performed at the time when an update instruction for the maximum aftertouch position is performed by the performer through operating the setting key 16d, for example instead of turning on the power as a trigger.

After the process of S31, the current velocity or acceleration of the white key 2a is obtained from the velocity memory 161c or the acceleration memory 162c. Then, whether a low-velocity state where the obtained velocity or acceleration is equal to or greater than the predetermined lower limit value Vh and equal to or less than the upper limit value Vi has continued for a predetermined time is verified (S32). In the case where the velocity or acceleration of the white key 2a is less than the predetermined lower limit value Vh or higher than the upper limit value Vi, or in the case where the duration of the low-velocity state of the white key 2a is short (S32: No), it can be determined that the white key 2a is in operation, so the series of processes is ended without updating the maximum aftertouch position.

Meanwhile, in the case where the current low-velocity state of the white key 2a has continued for the predetermined time (S32: Yes), whether the current position of the white key 2a is lower (deeper) than the current maximum aftertouch position stored in the correction value memory 161b is verified (S33). In the case where the current position of the white key 2a is at a height equal to or higher than the current maximum aftertouch position (S33: No), the series of processes is ended without updating the maximum aftertouch position.

Meanwhile, in the case where the current position of the white key 2a is deeper than the current maximum aftertouch position in the process of S33 (S33: Yes), it can be estimated that the performer is providing the maximum effect of aftertouch performance. In this case, whether the difference between the current position of the white key 2a and the current maximum aftertouch position stored in the correction value memory 161b falls within a predetermined range is verified (S34). In the case where the difference falls outside the predetermined range (the difference is too large) (S34: No), the maximum aftertouch position stored in the correction value memory 161b has fluctuated significantly. Therefore, the series of processes is ended without updating the maximum aftertouch position.

Meanwhile, in the case where the difference in S34 falls within the predetermined range (S34: Yes), the correction value memory 161b is referenced, and a position obtained by averaging the current position of the white key 2a and the maximum aftertouch position set in the past (correction value stored in the correction value memory 161b), or a position obtained through weighted calculation, is stored in the correction value memory 161b as the correction value for the maximum aftertouch position (S35), and the series of processes is ended.

The process of S35, similar to the processes of S18 and S26, determines the update value of the maximum aftertouch position by using the calculation method of “((sum of update values of maximum aftertouch position for N times in the past)+(current position of white key 2a))/(N+1)” or “(previous update value of maximum aftertouch position)×(1−P)+current position of white key 2a×P (for example, P=0.01)”. Accordingly, the update of the maximum aftertouch position can be gradually corrected.

As described above, according to the keyboard device 1 of the embodiment, the sensor output values indicating the respective positions of the static position, the terminal position of key-pressing, and the maximum aftertouch position of the white key 2a are corrected by the key position correction process (S4) (correction step). Then, based on the corrected sensor output value, the key-pressing information of the white key 2a is detected (key-pressing information detection step), so the key-pressing information of the white key 2a can be detected with high accuracy.

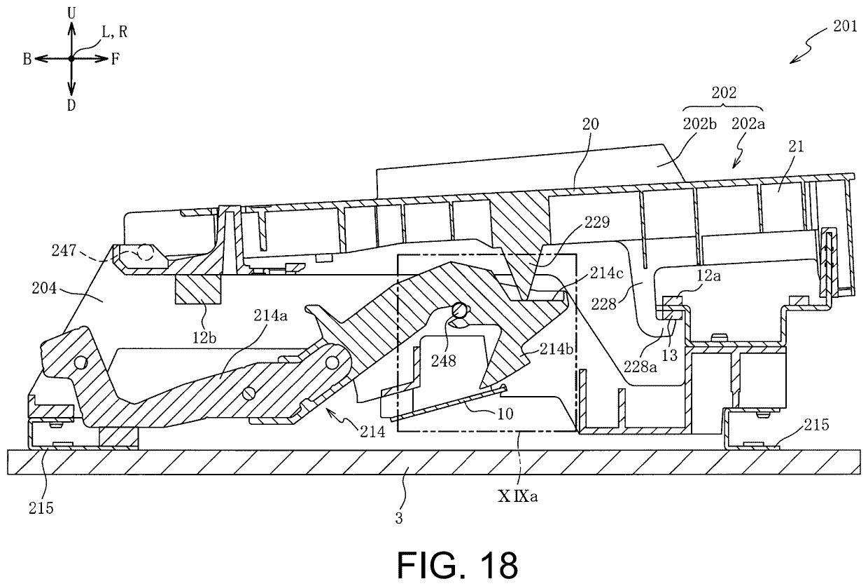

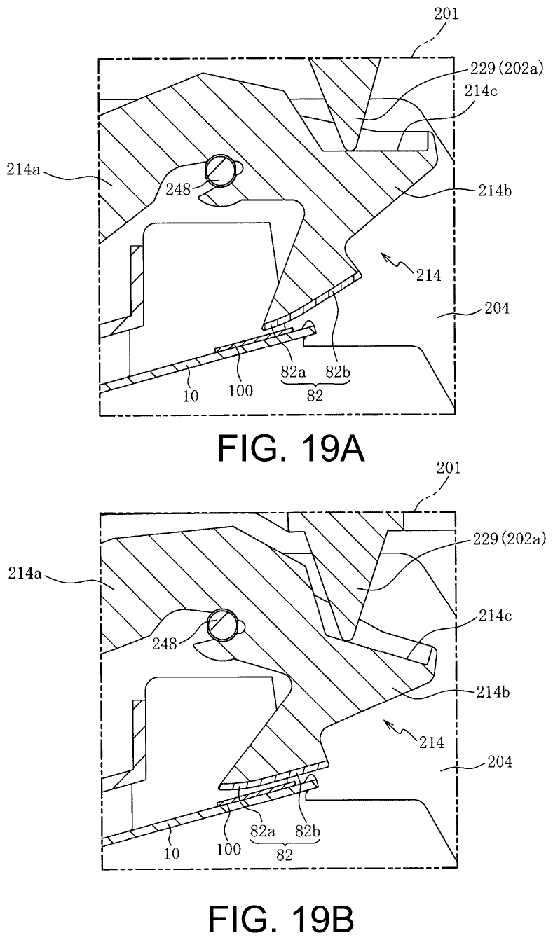

Next, referring to FIG. 18 and FIG. 19, a keyboard device 201 of the second embodiment will be described. In the first embodiment, the case where the detected part 82 is formed on the displacement member 8 linked to the white key 2a is described. However, in the second embodiment, a case where the detected unit 82 is formed on a hammer 214 linked to the white key 202a will be described. It should be noted that the same reference numerals are assigned to the same parts as in the first embodiment described above, and their explanations are omitted.

FIG. 18 is a cross-sectional view of the keyboard device 201 in the second embodiment. FIG. 19A is a partially enlarged cross-sectional view of the keyboard device showing an enlarged view of an XIXa portion in FIG. 18, and FIG. 19B is a partially enlarged cross-sectional view of the keyboard device showing the state where the white key is pressed from the state in FIG. 19A to the maximum aftertouch position.

As shown in FIG. 18, the keyboard device 201 includes multiple (in this embodiment, 88) keys 202, and is a device that forms a keyboard instrument (electronic piano). The keys 202 are formed by white keys 202a and black keys 202b, and the white keys 202a and black keys 202b are arranged in the scale direction (arrow L-R direction).

On the upper surface of the base plate 3, a resin chassis 204 is supported via a channel material 215. On the upper surface of the rear end side (the end on the arrow B side) of the chassis 204, a rotation shaft 247 of the key 202 is provided, and the rear end portion of each key 202 is pivotally supported by the rotation shaft 247.

In the substantially central portion of the chassis 204 in the front-rear direction (arrow F-B direction), the hammer 214 is rotatably supported around a rotation shaft 248 extending along the scale direction. The hammer 214 includes a mass part 214a (mass body) for providing a key-pressing feel during the pressing of the white key 2a, and the mass part 214a is positioned on the rear side (arrow B side) with respect to the rotation shaft 248.

The portion of the hammer 214 on the front side (arrow F side) with respect to the rotation shaft 248 is configured as a facing part 214b that faces the substrate 10 when the white key 202a is pressed. On the upper surface of the facing part 214b, a receiving part 214c that is concave downward is formed, and a protrusion part 229 of the white key 2a is inserted into the receiving part 214c.

The protrusion part 229 protrudes downward from the lower surface of the substantially central portion of the upper plate 20 of the white key 202a in the front-rear direction. The bottom surface of the receiving part 214c is configured as a slide surface on which the tip (lower end) of the protrusion part 229 slides in the front-rear direction.

As shown in FIG. 19, when the white key 202a is pressed, the protrusion part 229 slides along the bottom surface of the receiving part 214c of the hammer 214, while the facing part 214b is pushed downward by the protrusion part 229, thereby rotating the hammer 214 about the rotation shaft 248 (clockwise in FIG. 19). Through the rotation of the hammer 214, the facing part 214b of the hammer 214 is displaced with respect to the substrate 10. In the following description, the outer surface of the hammer 214 that faces toward a direction perpendicular to the axial direction (scale direction) of the rotation shaft 248 will be referred to as the “outer peripheral surface”.

On the outer peripheral surface of the facing part 214b of the hammer 214, the detected part 82 similar to that of the first embodiment is formed by adhering a plate of a non-magnetic metal (such as copper) or through plating.

As the stroke length of the white key 202a increases from the static position before key-pressing, the penetration amount of the detected part 82 into the detection region increases. Meanwhile, in the case where the white key 202a is released after being pressed, the hammer 214 rotates (counterclockwise in FIG. 19) to return to the static position due to the weight of the mass part 214a. Through the rotation of the hammer 214, the penetration amount of the detected part 82 into the detection region decreases. As a result, the inductance (sensor output value) of the coil 100 changes, and based on the change, the key-pressing information is detected.

In the detected part 82, a curved surface part 82a positioned on the front side in the rotation direction of the hammer 214 at the time of key-pressing and a plane part 82b connected to the rear side of the curved surface part 82a in the same rotation direction are formed. The curved surface part 82a is formed in a convex curved shape in a direction away from the rotation shaft 248 of the hammer 214, and the plane part 82b is formed as a plane extending in the tangential direction of the rear end (the end on the arrow F side) of the curved surface part 82a.

In this way, in the embodiment as well, since the curvature of the plane part 82b is smaller than the curvature of the curved surface part 82a of the detected part 82, the distance between the coil 100 and the detected part 82 (plane part 82b) in the performance region of the aftertouch can be reduced. Accordingly, the dynamic range can be expanded, and therefore the sensor output value in the performance region of the aftertouch can be significantly reduced.

As shown in FIG. 18, when the white key 202a is pressed, the swinging of the white key 202a is regulated by the key-pressing stopper 12a that contacts the lower surface of the white key 202a and the key-pressing stopper 12b that contacts the mass part 214a of the hammer 214.

While not shown in the drawings, in each of the stoppers 12a and 12b, layers 120 to 122 (see FIG. 9) are laminated like the key-pressing stopper 12 of the first embodiment. Accordingly, during normal performance, a relatively firm full-stroke feel is imparted by the rigid layer 121 (see FIG. 9), while during aftertouch performance, the white key 202a can be significantly displaced due to the deformation of the first cushion layer 120. As a result, normal performance and aftertouch can be accurately distinguished and detected.

Additionally, a stopper part 228 extends downward from the side plate 21 of the white key 202a, and a bending part 228a bends toward the front side (arrow F side) from the lower end of the stopper part 228. The swinging of the white key 202a at the time of key release is regulated by the key-releasing stopper 13, which is attached to the chassis 204, contacting the bending part 228a.

Although not shown in the drawings, in the key-releasing stopper 13 as well, the layers 130 to 132 (see FIG. 9) are laminated like the key-releasing stopper 13 of the first embodiment mentioned above. Therefore, at the time of releasing the white key 202a, the rigid layer 131 can regulate the bending part 228a from deforming to bite into the first cushion layer 130. Therefore, the durability of the key-releasing stopper 13 can be improved.

The invention has been described based on the embodiments, but it is not limited to these embodiments. It can be easily inferred that various improvements and modifications are possible within the scope of the invention without departing from the spirit of the invention.

In the embodiments, the case where normal performance and aftertouch are detected based on the output value of the coil 100 have been described, but the invention is not necessarily limited thereto. For example, separate sensors for detecting normal performance and aftertouch may be provided, or a configuration that does not detect aftertouch may also be used.

In the embodiments, a non-magnetic metal (such as copper) is exemplified as an example of the material of the detected part 82 that changes the magnetic field of the coil 100. However, the material of the detected part 82 may be a magnetic metal or a non-metallic material as long as the material is conductive. Examples of the non-metallic material includes conductive polymers (conductive rubber or conductive resin), carbon, and graphite. In other words, the material of the detected part 82 82 is not limited as long as it has the property of generating eddy currents in response to changes in the magnetic field.

In the embodiments, the coil 100 is exemplified as an example of the sensor for detecting key-pressing information (normal performance and aftertouch) of the white key 2a, 202a, but the invention is not necessarily limited thereto. For example, a sensor that detects key-pressing information based on changes in electrostatic capacity may be used, or key-pressing information may be detected using other conventional non-contact sensors (e.g., the sensor described in Japanese Patent Application Laid-Open Publication No. H03-048295) or contact sensors (for example, the pressure sensor described in Japanese Patent Application Laid-Open Publication No. H08-234751).

In the embodiments, the case where the detection unit 82 is formed on the displacement member 8 or the hammer 214 that rotates in conjunction with the swinging of the key 2, 202 is described, but the invention is not necessarily limited thereto. For example, the detection unit 82 may be formed on a displacement member that linearly displaces in conjunction with the swinging of the key 2, 202. An example of such a linearly displacing displacement member is the displacement member 307 described in FIGS. 15 and 16 of PCT/JP2022/032673.

In the embodiments, the case where the detected part 82 is formed by the curved surface part 82a formed in an arc shape (curved shape convex in the direction away from the rotation shaft 90, 248) centered on the rotation shaft 90, 248, and the plane part 82b that is planar and extends in the tangential direction from the rear end of the curved surface part 82a has been described, but the invention is not necessarily limited thereto. For example, the curved surface part 82a may be omitted and the entire detected part 82 may be formed in a plate shape, or the plane part 82b may be omitted and the detected part 82 may be formed in one arc shape. Also, the plane part 82b may be a curved surface with a smaller curvature than the curved surface part 82a.

In the embodiments, the case where the plane part 82b and the coil 100 (substrate 10) face and are substantially parallel to each other in the performance region of aftertouch (maximum aftertouch position) have been described. However, in the same region (terminal position of key-pressing), the plane part 82b and the coil 100 (substrate 10) may be not parallel to each other.

In the embodiments, the case where the key-pressing stopper 12, 12a contacts the lower surface of the white key 2a, 202a, or where the key-pressing stopper 12b contacts the hammer 214 has been described. However, the arrangement of the key-pressing stopper 12, 12a, 12b can be set as appropriate. Therefore, for example, the displacement of the white key 2a, 202a may also be regulated by making the key-pressing stopper 12, 12a contact the lower surface of the stopper part 28, 228 (bending part 28a, 228a).

In the embodiments, the case where the displacement of the white key 2a, 202a at the time of key-pressing is regulated by the key-pressing stopper 12 including the first cushion layer 120, the rigid layer 121, and the second cushion layer 122 have been described, but the invention is not necessarily limited thereto. For example, some of the layers 120 to 122 may be omitted, or other layers may be added in addition to the layers 120 to 122. As an example of a configuration of adding another layer, a configuration that adds felt between the first cushion layer 120 and the support part 41 of the chassis 4 is exemplified.

In the embodiments, the case where the first cushion layer 120 is made of foam urethane, the rigid layer 121 is made of PET, and the second cushion layer 122 is made of felt have been described, but the invention is not necessarily limited thereto. Other elastic materials such as rubber, elastomers (synthetic resin), or foam materials using these resins may be used to form the respective layers 120 to 122. In other words, the material of each of the layers 120 to 122 can be changed as appropriate. For example, in accordance with JIS K6253-3:2012, in the case of measuring the hardness of each of the layers 120 to 122 with a durometer type A hardness tester, a configuration where the hardness of the rigid layer 121 (second cushion layer 122) is higher than the first cushion layer 120, or a configuration where the hardness of the second cushion layer 122 is lower than the rigid layer 121 may also be adopted.

In the embodiments, the case where the swinging of the multiple keys 2, 202 (for example, keys 2, 202 for one octave) arranged in the scale direction is regulated by one key-pressing stopper 12, 12a, 12b or a key-releasing stopper 13 have been described, but the invention is not necessarily limited thereto. For example, the key-pressing stopper 12 or the key-releasing stopper 13 may be provided for each key 2, 202.

In the embodiments, the case where the thickness of the rigid layer 121 is less than the thickness of the first cushion layer 120, or where the thickness of the second cushion layer 122 is greater than the rigid layer 121 and less than the first cushion layer 120 has been described, but the invention is not necessarily limited thereto. For example, the thickness of the rigid layer 121 may be thicker than the first cushion layer 120. Also, the thickness of the second cushion layer 122 may be less than the rigid layer 121, or may be greater than the first cushion layer 120.

In the embodiments, the case where the correction processes (S2 to S4) for the static position, the terminal position, and the maximum aftertouch position of the white key 2a are repeatedly executed when the power of the keyboard device 1 is on has been described, but the invention is not necessarily limited thereto. For example, the correction process for the static position of the white key 2a may be sufficient to perform once after the power of the keyboard device 1 is turned on. Meanwhile, for, it may also be that the maximum aftertouch position is updated every time the keyboard device 1 is operated to handle a deeper aftertouch operation during performance. Therefore, after the static position of the white key 2a is corrected once in the correction process of S2, the process may also be skipped, and only the correction processes (S3, 4) for the terminal position and the maximum aftertouch position of the white key 2a are repeated.

In addition, regarding the estimated value of the terminal position of key-pressing, it is difficult to obtain the accurate position through one key-pressing. Therefore, the estimated value of the terminal position may be obtained by taking the average of the estimated values of multiple times. Therefore, in the correction process for the terminal position (S3), it may also be that the processes of S25 and S26 are executed after the processes S20 to S24 are executed multiple times.

Furthermore, after the power of the keyboard device 1 is turned on and the terminal position of key-pressing is corrected once in the process of S26, it may also be that the correction process for the terminal position (S3) is skipped, and only the correction processes (S2, 4) for the static position and the maximum aftertouch position of the white key 2a are repeatedly executed, or only the correction process (S4) for the maximum aftertouch position are repeatedly executed.

Moreover, in the case where the keyboard device 1 does not possess an aftertouch function as in the embodiment, it may also be that the correction process (S4) for the maximum aftertouch position is omitted and only the correction processes (S2, 3) for the static position of the white key 2a and the terminal position of key-pressing are executed. In other words, the timing for performing the processes S2-S4 can be arbitrarily changed. Moreover, it may also be that the processes S2 and 4 are omitted and only the correction process of S3 for the terminal position is executed.

In the embodiments, the case as follows has been described: in the terminal position correction process (S3), the determination on whether the white key 2a has reached the terminal position is made under the following conditions: in the process of S20, “the current position of the white key 2a is below or equal to the predetermined upper limit value Vc”; in the process of S21, “the deceleration of the white key 2a at the time of reaching the terminal position is below or equal to the predetermined upper limit value Ve”; and in the process of S23, “the velocity or the acceleration of the white key 2a immediately before reaching the terminal position is above or equal to the predetermined lower limit value Vf (or below or equal to the upper limit value Vg)”. However, the invention is not necessarily limited thereto.

For example, it may also be that some of the processes S20, 21, and 23 are omitted, or all of the processes S20, 21, and 23 are omitted, and a configuration that only the process of S22, which “determines that the white key 2a has reached the terminal position in the case where the deceleration of the white key 2a becomes above or equal to a predetermined lower limit value”, is performed.

In the embodiments, it is described that in the process of S24, “the estimated value of the terminal position is calculated based on the velocity or acceleration of the white key 2a immediately before reaching the terminal position”; in process S25, “determining whether the difference between the estimated value and the current terminal position is within a predetermined range”; and in process of S26, “the correction amount of the sensor output value is adjusted based on the correction values in the past as stored in the correction value memory 161b”. However, the invention is not necessarily limited to these processes.

For example, it may also be that some of the processes S24 to S26 are omitted, or all of the processes S24 to S26 are omitted, and a configuration that corrects the sensor output value indicating the height of the white key 2a at the time when it is determined to have reached the terminal position to a new sensor output value at the terminal position is adopted.

Similarly, in the static position correction process (S2), it may also be that one of S17 or S18 is omitted. Also, it may also be that both S17 and S18 are omitted. In the case where a predetermined time has elapsed from the start time of the white key 2a being static (S16: Yes), the sensor output value indicating the height of the white key 2a at this time is corrected to a new sensor output value at the static position.

Additionally, in the correction process for the maximum aftertouch position, it may also be that some of S32, 34, and 35 are omitted. Furthermore, it may also be that all of S32, 34, and 35 are omitted, and in the case where the current position of the white key 2a is lower than the current maximum aftertouch position (S33: Yes), the sensor output value indicating the height of the white key 2a at this time is corrected to a new sensor output value at the maximum aftertouch position.

In the embodiments, the case as follows is described: in the case where the magnitude of the negative acceleration of the white key 2a during key pressing becomes above or equal to the predetermined lower limit value Vd, it is determined that the white key 2a has reached the terminal position. However, the invention is not necessarily limited thereto. For example, it may also be configured to make a determination that the white key 2a reaches (or have reached) the terminal position (in such case, to correct the terminal position based on the position of the white key 2a at this time) in the case where the change in velocity or acceleration of the white key 2a at the time when the key is released from the terminal position (i.e., the magnitude of the negative velocity or acceleration when the key pressing direction is defined as positive) becomes above or equal to the predetermined lower limit value.

In the first embodiment, it is described that the substrate 10 is supported by the chassis 4 (indirectly) through the holder 9 by attaching the substrate 10 to the holder 9. However, the invention is not limited thereto. It may also be configured that the substrate 10 is attached to the chassis 4 (the substrate 10 is directly supported by the chassis 4). That is, “the substrate 10 supported by the chassis 4 (support member)” is a concept that covers both that the substrate 10 is indirectly attached to the chassis 4 and the substrate 10 is directly attached to the chassis 4. However, it may also be that the substrate 10 is supported on the base plate 3, and the support position of the substrate 10 can be changed as appropriate.

In the first embodiment, it is described that an end (front end) of the substrate 10 is inserted into the protrusions 96, 97 of the holder 9, while the other end (rear end) of the substrate 10 is screwed to the fixed part 112 of the fixed member 11. However, the invention is not necessarily limited thereto. For example, it may also be that an end of the substrate 10 is screwed to the holder 9, or an end of the substrate 10 is hooked onto an elastic claw formed on the holder 9. Additionally, it may also be that a pair of protrusions similar to the protrusions 96, 97 are formed on the fixed member 11 and the other end of the substrate 10 is inserted into that pair of protrusions, and the other end of the substrate 10 is hooked onto an elastic claw formed on the fixed member 11.

In the first embodiment, it is described that the key shaft member 5, the holder 9, and the fixed member 11 are separate parts. However, it may be also be that some or all of the components are integrally formed.

In the first embodiment, the case where multiple key shaft members 5, holders 9, and fixed members 11 are arranged in the scale direction. However, the invention is not necessarily limited there. For example, it may also be configured that all of the the keys 2 arranged in the scale direction are pivotally supported by one key shaft member 5, or a configuration where all of the displacement members 8 arranged in the same direction are pivotally supported by one holder 9. Additionally, it may also be configured that the substrate 10 is supported by one fixed member 11.

In the first embodiment, it is described that the guide pin 73 is formed on the linkage member 7 attached to the white key 2a, while the groove 80 engaged with the guide pin 73 is formed on the displacement member 8. However, it may be also be that a groove is formed in the linkage member 7, while a guide pin engaged with the groove is formed on the displacement member 8. Additionally, it may also be that the linkage member 7 (guide pin 73) is integrally formed with the white key 2a.

In the first embodiment, the case where a part of the holder 9 (wall part 91, attached part 92, and connection part 95) positioned on the displacement trajectory of the displacement member 8 functions as a regulation component that regulates the contact between the detected part 82 (plane part 82b) and the coil 100. However, the invention is not necessarily limited thereto. For example, it may be that a part that regulates the displacement of the displacement member 8 is provided on the chassis 4 (support part 41) or other components supported by that chassis 4.

In the first embodiment, it is described that the white key 2a and the holder 9 are assembled on the same chassis 4 (support part 41). However, it may also be that the white key 2a and the holder 9 are assembled on separate components.

### Others

A keyboard device according to Technical Concept 1 includes: a key (the white key 2a) that displaces between a static position before key-pressing and a terminal position of key-pressing; and a sensor (the coil 100) that outputs an output value increased or decreased in accordance with a position of the key. The keyboard device detects acceleration/deceleration of the key in a key-pressing direction from an output value of the sensor, and corrects the output value of the sensor indicating the terminal position based on the position of the key where the deceleration occurs.

Regarding the keyboard device according to Technical Concept 2, the keyboard device of Technical Concept 1 includes: a deceleration detection unit (17e) (the process of S22) that detects the deceleration (the magnitude of the negative acceleration) of the key based on the output value of the sensor; an arrival determination unit (17f) (the processes of S20 to S23), making a determination that the key has reached the terminal position in a case where the magnitude of the deceleration of the key as detected by the deceleration detection unit is equal to or greater than a predetermined lower limit value; and a correction unit (17a) (the process of S26), correcting the output value of the sensor indicating the terminal position based on a position (height) of the key in a case where the arrival determination unit determines that the terminal position is reached.

Regarding the keyboard device according to Technical Concept 3, in the keyboard device of Technical Concept 2, the arrival determination unit (17f) (the processes of S20 to S23) determines that the key has reached the terminal position in a case where the magnitude of the deceleration of the key as detected by the deceleration detection unit is equal to or less than a predetermined upper limit value (S21: Yes).

Regarding the keyboard device according to Technical Concept 4, the keyboard device of Technical Concept 2 includes: a velocity detection unit (the process of S1) that detects a velocity or an acceleration of the key in the key-pressing direction based on the output value of the sensor. The arrival determination unit (17f) (the processes of S20 to S23) determines that the key has reached the terminal position in a case where a magnitude of the velocity or the acceleration of the key as detected by the velocity detection unit before reaching the terminal position is equal to or higher than a predetermined lower limit value (S23: Yes).

Regarding the keyboard device according to Technical Concept 5, the keyboard device of Technical Concept 2 includes: a velocity detection unit (the process of S1) that detects a velocity or an acceleration of the key in the key-pressing direction based on the output value of the sensor. The arrival determination unit (17f) (the processes of S20 to S23) determines that the key has reached the terminal position in a case where a magnitude of the velocity or the acceleration of the key as detected by the velocity detection unit before reaching the terminal position is equal to or lower than a predetermined upper limit value (a modified example of the process of S23).

Regarding the keyboard device according to Technical Concept 6, in the keyboard device of Technical Concept 2, the arrival determination unit (17f) (the processes of S20 to S23) determines that the key has reached the terminal position in a case where the position of the key is equal to or less than a predetermined upper limit value (S20: Yes).

Regarding the keyboard device according to Technical Concept 7, the keyboard device of Technical Concept 2 includes: a velocity detection unit (the process of S1) that detects a velocity or an acceleration of the key in the key-pressing direction based on the output value of the sensor; and an estimation unit (the process of S24), calculating an estimated value of the terminal position based on the velocity or the deceleration of the key as detected by the velocity detection unit before the terminal position is reached. The correction unit corrects the output value of the sensor indicating the terminal position based on an estimated value calculated by the estimation unit.

Regarding the keyboard device according to Technical Concept 8, in the keyboard device of Technical Concept 7, the estimation unit (the process of S24) sets, as the estimated value, a position higher or lower than a position of the key at a time when the terminal position is reached in accordance with the magnitude of the velocity or acceleration of the key before the terminal position is reached.

Regarding the keyboard device according to Technical Concept 9, the keyboard device of Technical Concept 2 includes: a correction value storage unit (17b) (correction value memory 161b) storing a correction value of the output value of the sensor that is corrected by the correction unit. The correction unit (17a, the process of S26) adjusts a correction amount of the output value of the sensor based on a past correction value stored in the correction value storage unit.

Regarding the keyboard device according to Technical Concept 10, the keyboard device of Technical Concept 9 includes: a calculation unit (the process of S26), calculating an average of the output value of the sensor indicating the position (height) of the key in a case where the arrival determination unit determines that the terminal position is reached as well as past correction values of multiple times as stored in the correction storage unit. The correction unit corrects the output value of the sensor indicating the terminal position based on a value calculated by the calculation unit.

Regarding the keyboard device according to Technical Concept 11, the keyboard device of Technical Concept 9 includes: a calculation unit (the process of S26), calculating a value obtained by performing weighted calculation on the output value of the sensor indicating the position (height) of the key in the case where the arrival determination unit determines that the terminal position is reached, as well as a past correction value stored in the correction value storage unit. The correction unit corrects the output value of the sensor indicating the terminal position based on a value calculated by the calculation unit.

Regarding the keyboard device according to Technical Concept 12, the keyboard device of Technical Concept 2 includes: a correction value storage unit (17b) (correction value memory 161b) storing a correction value of the output value of the sensor that is corrected by the correction unit. The correction unit does not correct the output value of the sensor in a case where a difference between the output value of the sensor indicating the position (height) of the key in the case where the arrival determination unit determines that the terminal position is reached and a current correction value stored in the correction storage unit is equal to or greater than a predetermined difference (S25: No).

Regarding the keyboard device according to Technical Concept 13, the keyboard device of Technical Concept 2 includes: a position detection unit (17c) (the process of S10), detecting whether the position of the key is at a height equal to or greater than a predetermined height based on the output value of the sensor; and a time determination unit (17d) (the process of S16), determining whether a detection time during which the position of the key detected by the position detection unit is at the height equal to or greater than the predetermined height has continued for a predetermined time. The keyboard device includes: the correction unit (17a) (the process of

S18), correcting the output value of the sensor indicating a static position based on the position (height) of the key in a case where the time determination unit determines that the detection time has continued for the predetermined time; and a correction value storage unit (17b) (correction value memory 161b) storing a correction value of the output value of the sensor that is corrected by the correction unit. The correction unit adjusts a correction amount of the output value of the sensor based on a past correction value stored in the correction value storage unit.

Regarding the keyboard device according to Technical Concept 14, the keyboard device of Technical Concept 2 includes: the sensor, detecting, as aftertouch, a displacement of the key at a time when the key is further pushed into an aftertouch position lower than the terminal position; a velocity detection unit (17g) (the process of S32), detecting whether a magnitude of a velocity or an acceleration of the key is in a low-velocity state equal to or less than a predetermined upper limit based on the output value of the sensor; a time determination unit (17d) (the process of S32), determining whether a detection time during which the velocity detection unit detects the low-velocity state of the key has continued for a predetermined time; the correction unit (17a) (the process of S35), correcting the output value of the sensor indicating the aftertouch position based on the position of the key in a case where the time determination unit determines that the detection time has continued for the predetermined time; and a correction value storage unit (17b) (correction value memory 161b) storing the output value of the sensor that is corrected by the correction unit. The correction unit corrects the output value of the sensor indicating the aftertouch position in a case where the position of the key is lower than the aftertouch position stored in the correction value storage unit (S33: Yes).

Regarding the keyboard device according to Technical Concept 15, the keyboard device of Technical Concept 14 includes: an update determination unit (the process of S30), determining whether it is a timing in which the current aftertouch position stored in the correction value storage unit (17b) (the correction value memory 161b) is supposed to be updated; and an update unit (the process of S31), storing, as a new aftertouch position, a position higher than the current after touch position in the correction value storage unit in a case where the update determination unit determines that it is a timing in which the aftertouch position is supposed to be updated.

A method for detecting key-pressing information according to Technical Concept 16 is a method for a keyboard device including: a key (the white key 2a) that displaces between a static position before key-pressing and a terminal position of key-pressing; and a sensor (the coil 100) that outputs an output value increased or decreased in accordance with a position of the key. The method causes a computer to execute: detecting a deceleration (the magnitude of the negative acceleration) of the key in a key-pressing direction from the output value of the sensor (the process of S22); correcting the output value of the sensor indicating the terminal position based on a position (height) of the key at which the deceleration is detected (the process of S26); and detecting key-pressing information of the key based on the output value of the sensor as corrected.

What is claimed is:

1. A keyboard device, comprising:
a key configured to displace between a static position before key-pressing and a terminal position of key-pressing; and
a sensor configured to output an output value increased or decreased in accordance with a position of the key,
wherein the keyboard device is configured to detect acceleration/deceleration of the key in a key-pressing direction from the output value of the sensor, and correct the output value of the sensor indicating the terminal position based on the position of the key where the deceleration occurs.

2. The keyboard device according to claim 1, comprising:
a deceleration detection unit comprising a processor configured to detect the deceleration of the key based on the output value of the sensor;
an arrival determination unit comprising the processor configured to make a determination that the key has reached the terminal position in a case where a first magnitude of the deceleration of the key as detected by the deceleration detection unit is equal to or greater than a first predetermined lower limit value; and
a correction unit comprising the processor configured to correct the output value of the sensor indicating the terminal position based on the position of the key in a case where the arrival determination unit determines that the terminal position is reached.

3. The keyboard device according to claim 2, wherein the arrival determination unit determines that the key has reached the terminal position in a case where the first magnitude of the deceleration of the key as detected by the deceleration detection unit is equal to or less than a first predetermined upper limit value.

4. The keyboard device according to claim 2, comprising:
a velocity detection unit comprising the processor configured to detect a velocity or an acceleration of the key in the key-pressing direction based on the output value of the sensor,
wherein the arrival determination unit is configured to determine that the key has reached the terminal position in a case where a second magnitude of the velocity or the acceleration of the key as detected by the velocity detection unit before reaching the terminal position is equal to or higher than a second predetermined lower limit value.

5. The keyboard device according to claim 2, comprising:
a velocity detection unit comprising the processor configured to detect a velocity or an acceleration of the key in the key-pressing direction based on the output value of the sensor,
wherein the arrival determination unit is configured to determine that the key has reached the terminal position in a case where a second magnitude of the velocity or the acceleration of the key as detected by the velocity detection unit before reaching the terminal position is equal to or lower than a second predetermined upper limit value.

6. The keyboard device according to claim 2, wherein the arrival determination unit is configured to determine that the key has reached the terminal position in a case where the position of the key is equal to or less than a third predetermined upper limit value.

7. The keyboard device according to claim 2, comprising:
a velocity detection unit comprising the processor configured to detect a velocity or an acceleration of the key in the key-pressing direction based on the output value of the sensor; and
an estimation unit comprising the processor configured to calculate an estimated value of the terminal position based on the velocity or the acceleration of the key as detected by the velocity detection unit before the terminal position is reached, wherein the correction unit is configured to correct the output value of the sensor indicating the terminal position based on the estimated value calculated by the estimation unit.

8. The keyboard device according to claim 7, wherein the estimation unit is configured to set, as the estimated value, a position higher or lower than the position of the key at a time when the terminal position is reached in accordance with the second magnitude of the velocity or acceleration of the key before the terminal position is reached.

9. The keyboard device according to claim 2, comprising:
a correction value storage unit comprising a memory configured to store a correction value of the output value of the sensor that is corrected by the correction unit,
wherein the correction unit is configured to adjust a correction amount of the output value of the sensor based on a past correction value stored in the correction value storage unit.

10. The keyboard device according to claim 9, comprising:
a calculation unit comprising the processor configured to calculate an average of the output value of the sensor indicating the position of the key in a case where the arrival determination unit determines that the terminal position is reached as well as the past correction values of multiple times as stored in the correction storage unit,
wherein the correction unit is configured to correct the output value of the sensor indicating the terminal position based on the value calculated by the calculation unit.

11. The keyboard device according to claim 9, comprising:
a calculation unit comprising the processor configured to calculate a value obtained by performing weighted calculation on the output value of the sensor indicating the position of the key in the case where the arrival determination unit determines that the terminal position is reached, as well as the past correction value stored in the correction value storage unit,
wherein the correction unit is configured to correct the output value of the sensor indicating the terminal position based on the value calculated by the calculation unit.

12. The keyboard device according to claim 2, comprising:
a correction value storage unit comprising a memory configured to store a correction value of the output value of the sensor that is corrected by the correction unit,
wherein the correction unit is configured not to correct the output value of the sensor in a case where a difference between the output value of the sensor indicating the position of the key in the case where the arrival determination unit determines that the terminal position is reached and a current correction value stored in the correction storage unit is equal to or greater than a predetermined difference.

13. The keyboard device according to claim 2, comprising:
a position detection unit comprising the processor configured to detect whether the position of the key is at a height equal to or greater than a predetermined height based on the output value of the sensor; and
a time determination unit comprising the processor configured to determine whether a detection time during which the position of the key detected by the position detection unit is at the height equal to or greater than the predetermined height has continued for a predetermined time,
wherein the correction unit is configured to correct the output value of the sensor indicating the static position based on the position of the key in a case where the time determination unit determines that the detection time has continued for the predetermined time, and the keyboard device further comprises:
a correction value storage unit comprising a memory configured to store a correction value of the output value of the sensor that is corrected by the correction unit,
wherein the correction unit is configured to adjust a correction amount of the output value of the sensor based on a past correction value stored in the correction value storage unit.

14. The keyboard device according to claim 2, wherein the sensor is configured to detect, as aftertouch, a displacement of the key at a time when the key is further pushed into an aftertouch position lower than the terminal position,
wherein the keyboard device further comprises:
a velocity detection unit comprising the processor configured to detect whether a second magnitude of a velocity or an acceleration of the key is in a low-velocity state equal to or less than a second predetermined upper limit value based on the output value of the sensor;
a time determination unit comprising the processor configured to determine whether a detection time during which the velocity detection unit detects the low-velocity state of the key has continued for a predetermined time;
the correction unit configured to correct the output value of the sensor indicating the aftertouch position based on the position of the key in a case where the time determination unit determines that the detection time has continued for the predetermined time; and
a correction value storage unit comprising a memory configured to store the output value of the sensor that is corrected by the correction unit,
wherein the correction unit is configured to correct the output value of the sensor indicating the aftertouch position in a case where the position of the key is lower than the aftertouch position stored in the correction value storage unit.

15. The keyboard device according to claim 14, comprising:
an update determination unit comprising the processor configured to determine whether it is a timing in which the current aftertouch position stored in the correction value storage unit is supposed to be updated; and
an update unit comprising the processor configured to store, as a new aftertouch position, a position higher than the current after touch position in the correction value storage unit in a case where the update determination unit determines that it is a timing in which the aftertouch position is supposed to be updated.

16. A method for detecting key-pressing information for a keyboard device comprising a key that displaces between a static position before key-pressing and a terminal position of key-pressing; and a sensor that outputs an output value increased or decreased in accordance with a position of the key, the method causes a computer to execute:
detecting a deceleration of the key in a key-pressing direction from the output value of the sensor;
correcting the output value of the sensor indicating the terminal position based on a position of the key at which the deceleration is detected; and
detecting key-pressing information of the key based on the output value of the sensor as corrected.

17. The method according to claim 16, comprising:
determining that the key has reached the terminal position in a case where a first magnitude of the deceleration of the key is equal to or greater than a first predetermined lower limit value;
correcting the output value of the sensor indicating the terminal position based on the position of the key in a case where the key is determined to reach the terminal position.

18. The method according to claim 17, wherein the key is determined has reached the terminal position in a case where the first magnitude of the deceleration of the key is equal to or less than a first predetermined upper limit value.

19. The method according to claim 17, comprising:
detecting a velocity or an acceleration of the key in the key-pressing direction based on the output value of the sensor; and
determining that the key has reached the terminal position in a case where a second magnitude of the velocity or the acceleration of the key before reaching the terminal position is equal to or higher than a second predetermined lower limit value.

20. The method according to claim 17, comprising:
detecting a velocity or an acceleration of the key in the key-pressing direction based on the output value of the sensor; and
determining that the key has reached the terminal position in a case where a second magnitude of the velocity or the acceleration of the key before reaching the terminal position is equal to or lower than a second predetermined upper limit value.
